(19) United States
(12) Patent Application Publication
(10) Pub. No.: US 2023/0067434 A1
(43) Pub. Date: Mar. 2, 2023

(54) REASONING AND INFERRING REAL-TIME CONDITIONS ACROSS A SYSTEM OF SYSTEMS

(71) Applicant: Falkonry Inc., Sunnyvale, CA (US)

(72) Inventors: Suhas MEHTA, Santa Clara, CA (US); Christopher LEE, Fremont, CA (US); Nikunj R. MEHTA, Cupertino, CA (US); Daniel KEARNS, Half Moon Bay, CA (US)

(21) Appl. No.: 17/459,085

(22) Filed: Aug. 27, 2021

(51) Int. Cl. G06N 20/20; G06N 5/04

(52) U.S. Cl. CPC G06N 20/20; G06N 5/046

(57) ABSTRACT

Model chaining provides users with enormous flexibility to define their systems in a way that best suits their needs to get the most benefit from artificial intelligence models. In model chaining, a model chain may be generated. Output of a model is used as the signal input to another model. In this way, lower-level models can be more sensitive as they find patterns using just a few signals, and higher-level model then looks for patterns in the patterns of the lower-level models. All of the signals are used while users are not being blinded by more subtle behaviors.

### RELATED APPLICATIONS

This application is related to U.S. Pat. No. 10,409,926, titled “Learning Expected Operational Behavior of Machines from Generic Definitions and Past Behavior” and issued Sep. 10, 2019, U.S. Pat. No. 10,552,762, titled “Machine Learning of Physical Conditions Based on Abstract Relations and Sparse Labels” and issued Feb. 4, 2020, U.S. patent application Ser. No. 15/906,702, titled “System and Method for Explanation for Condition Predictions in Complex Systems” and filed Feb. 27, 2018, and U.S. patent application Ser. No. 16/939,568, titled “Fluid and Resolution-Friendly View of Large Volumes of Time Series Data” and filed Jul. 27, 2020, the entire contents of which are hereby incorporated by reference for all purposes as if fully set forth herein.

### TECHNICAL FIELD

One technical field of the present disclosure relates processing and visualization of structured sensor data and derived data. Another technical field relates to issue diagnosis and prediction for industrial systems. Yet another technical field relates to asset organization for industrial systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Modern industrial systems, such as a factory, a production site, or a naval ship, are inherently complex systems. These industrial systems are typically made up of hundreds of interconnected subsystems. These systems are heavily instrumented to improve diagnostics as well as to detect emergent behaviors, which results in thousands of sensor values getting produced at any given time.

However, software applications used to manage these systems generally have limited interest in understanding system structure and do not utilize most of these sensor values in an integrated manner. For example, Enterprise Asset Management or Asset Performance Management applications are configured to represent structured components of a system for the purpose of managing their maintenance or for visualizing their performance but are not configured to interpret the sensor values at a system level. As a result, they do not provide a good understanding of the system's operational state at any given time. Some engineering design tools capture schematics such as piping and instrumentation diagrams, which are meant for visualization rather than for analysis. This representation, while useful for observation and monitoring, cannot be readily used for analysis especially as industrial complexity tends to overload diagrams for non-analytical purposes.

In addition, traditional analysis methods for diagnostics and prediction treat each analysis of a subsystem as a flat mathematical process, whereby system structure and, therefore, engineering design are often lost. As a result, complex systems cannot be correctly analyzed without requiring a large amount of manual effort to map analysis results to an understanding of the overall system's operation. This limitation hinders root cause analysis of complex systems as well as their optimal operational management.

Traditional methods, therefore, do not adequately support the analysis of real-time data produced by complex systems to understand causes of their recent or past behavior. Thus, it would be helpful to have an improved solution to processing and visualizing large volumes of data of complex systems for understanding causes of system behavior.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example networked computer system in accordance with some embodiments.

FIG. 2 illustrates an example hierarchy showing parent-child asset relationships.

FIG. 3A illustrates an example of hierarchical organization of assets.

FIG. 3B illustrates another example of hierarchical organization of assets.

FIG. 3C illustrates yet another example of hierarchical organization of assets.

FIG. 4A illustrates an example of sequential organization of assets.

FIG. 4B illustrates an example sequential organization of assets at time t1.

FIG. 4C illustrates an example sequential organization of assets at time t2.

FIG. 4D illustrates an example sequential organization of assets at time t3.

FIG. 4E illustrates an example sequential organization of assets at time t4.

FIG. 4F illustrates an example sequential organization of assets at time t100.

FIG. 5 illustrates an example hybrid organization of assets.

FIG. 6 illustrates an example timeline view in accordance with some embodiments.

FIG. 7A illustrates an example timeline view in accordance with some embodiments.

FIG. 7B illustrates an example timeline view in accordance with some embodiments.

FIG. 8A illustrates an example timeline view in accordance with some embodiments.

FIG. 8B illustrates an example timeline view in accordance with some embodiments.

FIG. 9 illustrates an example graphical user interface (GUI) of converting a model to a signal in accordance with some embodiments.

FIG. 10 illustrates an example timeline view comparing multiple models in accordance with some embodiments.

FIG. 11A illustrates an example display showing analyzers monitored on a geo-spatial map in accordance with some embodiments.

FIG. 11B illustrates another example display showing analyzers monitored on a geo-spatial map in accordance with some embodiments.

FIG. 12A illustrates an example method of building models in accordance with some embodiments.

FIG. 12B illustrates an example method of analyzing model performance in accordance with some embodiments.

FIG. 13 illustrates diagrams of a hierarchical organization, a sequential organization and a hybrid organization of assets.

FIG. 14 provides an example block diagram of a computer system upon which an embodiment may be implemented.

FIG. 15 provides an example block diagram of a basic software system for controlling the operation of a computing device.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein in sections according to the following outline:

1.0. GENERAL OVERVIEW

2.0. DEFINITIONS

3.0. SYSTEM OVERVIEW

4.0. ASSET ORGANIZATION OVERVIEW
4.1. HIERARCHICAL ORGANIZATION
   4.1.1. BUILDING MODELS
   4.1.2. APPLYING MODELS IN REAL TIME
   4.1.3. ANALYZING MODEL PERFORMANCE
4.2. SEQUENTIAL ORGANIZATION
   4.2.1. OIL PROCESSING PLANT EXAMPLE
   4.2.2. AUTOMOBILE MANUFACTURING PLANT EXAMPLE
4.3. HYBRID ORGANIZATION

5.0. GRAPHICAL USER INTERFACE EXAMPLES
5.1. SIGNAL VISUALIZATIONS
   5.1.1. SIGNALS HIGHLIGHTED BY MODEL
   5.1.2. SIGNALS GROUPED BY MODEL AND SORTED BY CONTRIBUTION RANK
   5.1.3. OTHER EXAMPLE VISUALIZATION FEATURES
5.2. MODEL TO SIGNAL CONVERSION
5.3. MODEL COMPARISON
5.4. DIGITAL TWIN

6.0. PROCEDURAL OVERVIEW

7.0. HARDWARE OVERVIEW

8.0. SOFTWARE OVERVIEW

9.0. OTHER ASPECTS OF DISCLOSURE

### 1.0. General Overview

Techniques described herein model behavior of both discrete and composite systems. In discrete systems, behavior can be captured by independent models based on machine learning (ML). A compressor operating in isolation is an example of a “discrete” system because the behavior of the compressor can be understood by modeling only the compressor itself (i.e., without reference to any other systems in the plant). In composite systems, important behavior comes from the interaction of multiple discrete or composite subsystems such that understanding the overall composite system behavior requires multiple models describing interacting subsystems. It is from these interactions that the complete behavior is understood.

For example, in commercial space, a steel production plant is an example of a “composite” system because behavior of the overall plant can be understood only by modeling the interactions between the various subsystems (e.g. blast furnace, rolling mill, castor, pinch-rollers, cooling table, motors, etc.). For another example, in governmental space, the U.S. Navy's Zumwalt class destroyer is an example of a “composite” system because behavior of the ship can be understood only by modeling the interactions between the various subsystems (e.g., turbine generators, switchgear, water pumping systems, power conversion and distribution modules, etc.).

An approach to modeling is to put all of a system's signals into a model and use that data to learn behaviors of the system. For small systems, this approach works well as the number of signals is limited (e.g., tens to a few hundreds). However, for complex systems, this approach does not work well as the number of signals from all of the subsystems can easily reach into thousands or more. Patterns found directly from such a large number of disparate signals may be too high-level or superficial without truly capturing problematic behavior that might be traced to components at different levels of the system. Therefore, in modeling complex systems, a different approach is needed—one which reduces the signal count used to find patterns but that still accounts for interactions between the subsystems which generate all of those signals.

Techniques described herein relate to model chaining. Model chaining provides users with enormous flexibility to define their systems in a way that best suits their needs to get the most benefit from models. In model chaining, a model chain may be generated. A model chain includes a plurality of models “chained” together. Output of a model may be used as the signal input to another model. In this way, lower-level models can be more sensitive to local behavior as they find patterns using just a few signals, and higher-level models (e.g., a model of models) then look for patterns in the output of the lower-level models.

When a model chain finds or predicts abnormal behavior in the system, users are able to drill down to the specific signals which are responsible for the abnormal behavior by aligning and traversing multiple models across multiple Datastreams. Traversals enable the effective use of model chains for understanding complex systems.

Techniques described here further relate to improving learning and tracing the reliability, emission, quality, performance of industrial systems. The techniques also enable building an output product hierarchy that will capture the potential issue with the quality of the output product depending on the quality issue detected at a certain step(s) in the process of the assembly or processing.

In one aspect, a computer-implemented method comprises receiving an indication of an error state of a specific asset of a plurality of assets that is arranged in a hierarchy of a plurality of levels. Each asset of the plurality of assets is associated with at least one component of an industrial system. The plurality of levels includes a top level, a bottom level, and one or more intermediary levels between the top level and the bottom level. Each of the plurality of assets is associated with a machine learning (ML) model, thus forming a corresponding hierarchy of ML models. A first ML model associated with a first asset of the plurality of assets that is at the bottom level is configured to receive one or more signals corresponding to one or more values of sensors attached to one or more components of the industrial system in real time relative to generation of the one or more values. A second ML model associated with a second asset of the plurality of assets that is at the bottom level or at the one or more intermediary levels is configured to receive one or more signals to predict a condition of the second asset as output of the second ML model, wherein the output of the second ML model is used as an input signal by at least a third ML model associated with a third asset of the plurality of assets that is higher in the hierarchy than the second asset. The method also includes performing a diagnosis of the error state by traversing the hierarchy of the plurality of levels from the top level. The traversing the hierarchy comprises determining a particular input signal of one or more input signals for a ML model associated with an asset at a current level of the hierarchy satisfies an event, following the particular input signal to a ML model associated with an asset at a level lower than the current level, thereby visiting the asset at the lower level, and repeating the determining and the following until an asset of the plurality of assets is identified as a potential source of the error state indicated for the system.

Other embodiments, aspects, and features will become apparent from the reminder of the disclosure as a whole.

### 2.0. Definitions

Throughout the discussion herein, several acronyms, shorthand notations, and terms are used to aid the understanding of certain concepts pertaining to the associated system. These acronyms, shorthand notations, and terms are solely intended for the purpose of providing an easy methodology of communicating the ideas expressed herein and are in no way meant to limit the scope of the present invention.

Sensors associated with an industrial equipment or machine produce multiple signals forming time series data. Features can be identified from the time series data. Each feature can involve one or more signals (at the same time point) or one or more time points (for the same signal)—a time period can comprise any number of time points. Each feature corresponds to a relationship of the signal values across signals, time points, or both. Such relationships among signals, time series, features, and so on are further discussed in U.S. Pat. No. 10,552,762, titled “Machine Learning of Physical Conditions Based on Abstract Relations and Sparse Labels” and issued Feb. 4, 2020, for example.

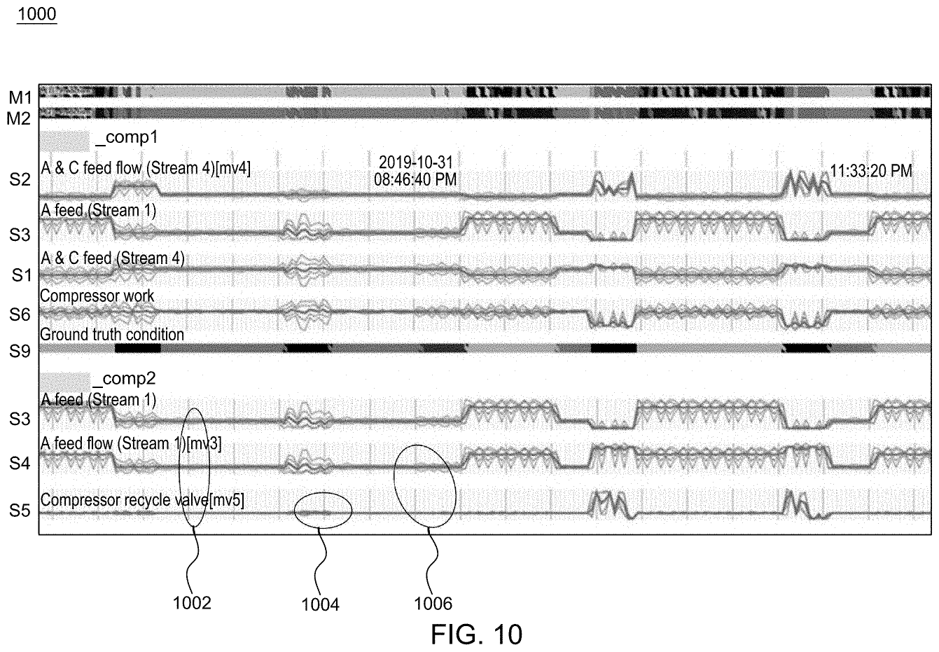

For example, referring to FIG. 10, the relationship between signals S3, S4, and S5, time series data (a first time series of values of S3 over time, a second time series of values of S4 over time, a third time series of values of S5 over time in this illustration). Features include feature 1002, feature 1004, and feature 1006 in this illustration, where S3 has (a component that is part of) feature 1002, S4 has feature 1002 and feature 1006, and S5 has feature 1002, feature 1004, and feature 1006.

A feature is a description of time series data across multiple signals and across time. A condition can be characterized by patterns detected in multiple features. A feature vector is a vector of features (or feature values). An example of a condition of a printer is that it is about to stop printing. A pattern characteristic of the condition could be that features related to ink levels show decreasing values over time. Another pattern characteristic of the condition could be features related to a first wireless signal being weak (below a certain threshold) and features related to a second wired signal being undetectable (zero) at the same time. Knowing which of the signals contribute most to the condition of the printer given the features is helpful. In certain embodiments, a feature represents a pattern in values produced by one or more signals over a period of time that occurs in multiple pieces of time series data. A feature vector could then represent the occurrence of one or more patterns in values of a signal, the set of values of a signal that correspond to when one or more patterns occur, or the set of values corresponding to a pattern.

Table A below provides additional, extended definitions. A full definition of any term can only be gleaned by giving consideration to the full breadth of this patent.

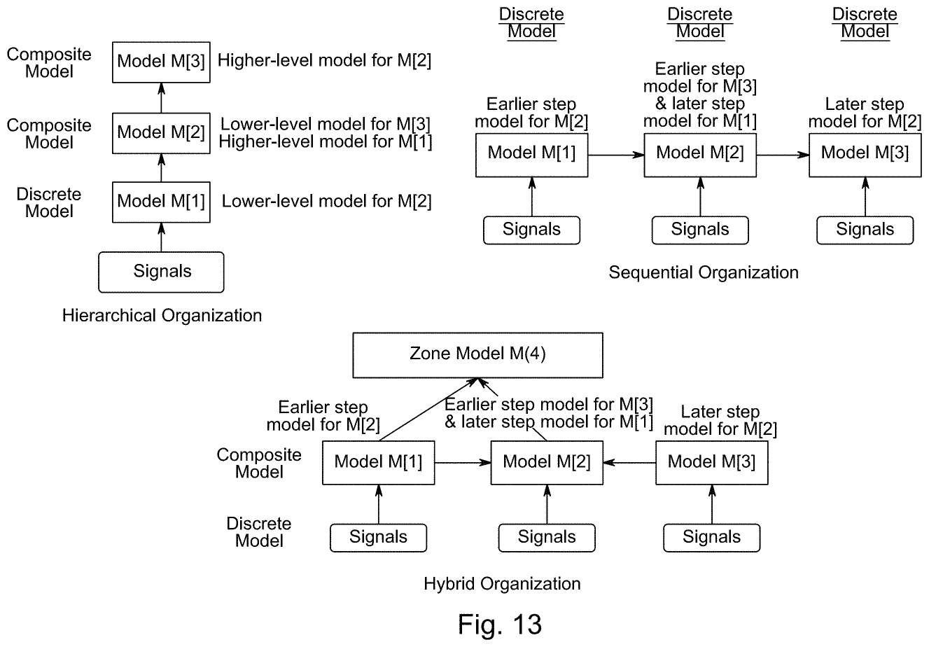

TABLE A

| | |
|---|---|
| Signal | A signal is a time-varying sequence of data; a series of <time, value> |
| | pairs. The time-series data consists of a set of signals. For example, |
| | each field sensor reading is captured as a sensor signal. Multiple |
| | signals can be combined to form multivariate time series data. |
| Prediction signal | The time-series prediction output of a model. This may be used as an |
| | input signal into other models. |
| Model | Based on sensor signals, historical data, facts, and specific parameters, |
| | a set of computer-executable instructions implementing a |
| | mathematical algorithm that discovers patterns from time-series data. |
| Composite model | A model that represents the behavior of one or more components in |
| | relation to each other. It may use one or more prediction outputs as |
| | input signals. |
| Discrete model | A model that represents the behavior of a single component or system. |
| | It will generally use only sensor signals as input to create prediction |
| | outputs. |
| Deep apply | A method to generate model predictions, for a given time period of |
| | data, using a depth-first traversal (similar to a depth-first search or |
| | DFS algorithm). This relies on that the lower-level models have the |
| | prediction output and is fed into a higher-level model before the |
| | prediction output for a higher-level model generated. |
| Building models or | Building the discrete (lower-level) models before building the |
| bottom-up | composite (higher-level) models. |
| Analyzing model | Analyzing the output and model performance of a composite (higher- |
| performance or top- | level) model before drilling down to the related discrete (lower-level) |
| down | models. |
| Hierarchical | The systems/assets are placed in a tree structure such that the lowest |
| organization of | component/equipment are at the leaf node (discrete models) and the |
| systems/assets | complex systems (of equipment, sub-equipment, systems, modules, |
| | zones, etc.) makes up the trunk or branches (composite models) of the |
| | tree. FIG. 13 illustrates an example hierarchical organization of |
| | systems/assets. |
| Sequential | Systems/assets that are placed in a linear structure and result in a |
| organization of | series of models starting with a discrete model followed by a series of |
| systems/assets | composite models. FIG. 13 illustrates an example sequential |
| | organization of systems/assets. |
| Hybrid organization | It is a combination of hierarchical and sequential organizations. This |
| of systems/assets | could be a graph structure of discrete as well as composite models that |
| | represent systems/assets. FIG. 13 illustrates an example hybrid |
| | organization of systems/assets. |
| Digital twin | A ML-based model (discrete or composite) that represents or predicts |
| | the operational condition of a physical component/asset in the real |
| | world. |
| Analyzer | A ML-based model (discrete or composite) that is deployed in the real |
| | world (e.g., deployed to run in an independent container on an edge |
| | server or equivalent compute device) for real-time monitoring of the |
| | physical component/asset. |
| Live Model | A ML-based model (discrete or composite) that is running on the |
| | server for real-time monitoring of the physical component/asset. |

### 3.0. System Overview

All drawing figures, all of the description and claims in this disclosure, are intended to present, disclose and claim a technical system and technical methods comprising specially programmed computers, using a special-purpose distributed computer system design and instructions that are programmed to execute the functions that are described. These elements execute functions that have not been available before to provide a practical application of computing technology to address the difficulty in efficiently and intelligently analyzing and visualizing large volumes of time series data in complex systems for understanding causes of behavior. In this manner, the disclosure has many technical benefits.

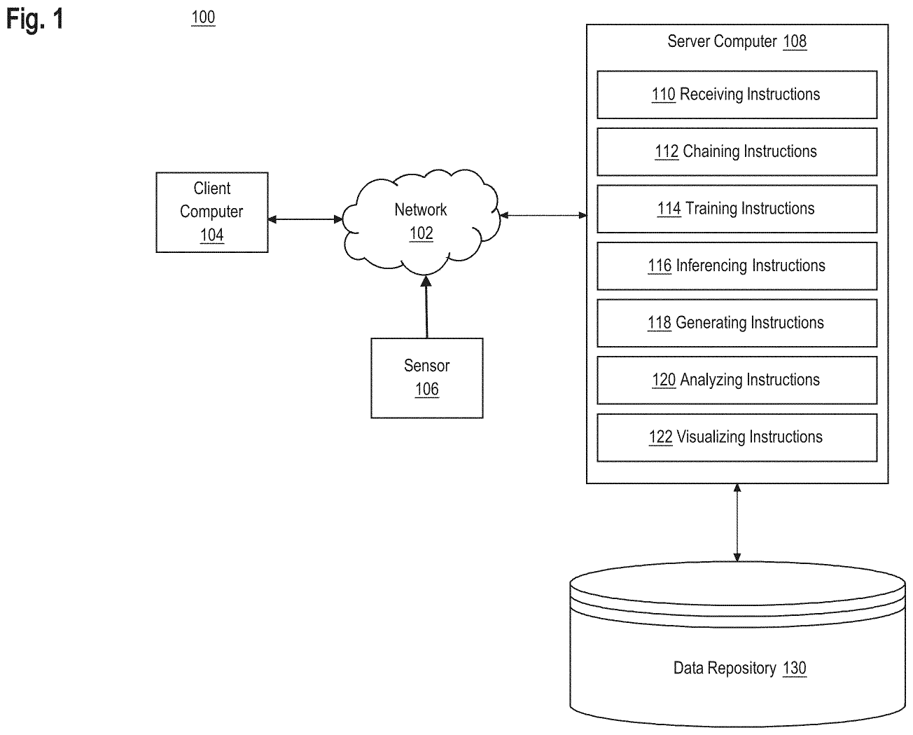

FIG. 1 is a block diagram of an example networked computer system 100 in which various embodiments may be practiced. FIG. 1 illustrates only one of many possible arrangements of elements configured to execute the programming described herein. Other arrangements may include fewer or different elements, and the division of work between the elements may vary depending on the arrangement.

In some embodiments, the networked computer system 100 comprises one or more client computers 104, one or more sensors 106, and a server computer 108, which are communicatively coupled directly or indirectly via network 102.

In the example of FIG. 1, the networked computer system 100 may facilitate the exchange of data between the client computers 104 and the server computer 108. Each of elements 104 and 108 of FIG. 1 may represent one or more computers that host or execute stored programs that provide the functions and operations that are described further herein in connection with processing and visualization operations.

The server computer 108 may comprise fewer or more functional or storage components. Each of the functional components can be implemented as software components, general or specific-purpose hardware components, firmware components, or any combination thereof. A storage component can be implemented using any of relational databases, object databases, flat file systems, or JSON stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In an embodiment, the server computer 108 executes receiving instructions 110, chaining instructions 112, training instructions 114, inferencing instructions 116, generating instructions 118, analyzing instructions 120, and visualizing instructions 122, the functions of which are described herein. Other sets of instructions may be included to form a complete system such as an operating system, utility libraries, a presentation layer, database interface layer and so forth. In addition, the server computer 108 may be associated with one or more data repositories 130.

The receiving instructions 110 may cause the server computer 108 to receive, over the network 102, operational data (e.g., actual/raw data) for processing and/or storage in the data repository 130. In an embodiment, the operational data may be time series data generated by field sensors 106. Time series data may be numerical or categorical. Example numerical time series data may relate to temperature, pressure, or flow rate generated by a machine, device, or equipment. Example categorical time series data has a fixed set of values, such different states of a machine, device, or equipment.

The chaining instructions 112 may cause the server computer 108 to select and connect machine learning (ML) models. The model chain may have a configuration that is hierarchical, sequential, or a hybrid of both. Each model in the model chain corresponds to a logical grouping of one or more assets, which are further discussed below. Each model receives and processes one or more input signals, and generates an estimated condition or signal patterns characterizing the condition as output. Output of a model may be routed as a signal feed for (e.g., input to) another model. In this manner, lower-level models may be more sensitive to local behavior of the system as they find patterns using just a few signals, while higher-level models find patterns in the patterns of the lower-level models. The model chain represents or reflects structures and process flows of a complex system (e.g., an industrial system).

Each model may be associated with machine learning approaches, including any one or more of: supervised learning (e.g., using gradient boosting trees, using logistic regression, using back propagation neural networks, using random forests, decision trees, etc.), unsupervised learning (e.g., using an Apriori algorithm, using K-means clustering), semi-supervised learning, a deep learning algorithm (e.g., neural networks, a restricted Boltzmann machine, a deep belief network method, a convolutional neural network method, a recurrent neural network method, stacked auto-encoder method, etc.), reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminant analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable machine learning approach.

The training instructions 114 may cause the server computer 108 to train each model using historical data, including past operational signals generated by field sensors and past prediction signals generated by models, and past actual conditions of assets. Each model may be retrained using new available data. Each model may be individually trained. Alternatively or in addition to, all models may be trained together.

The inferencing instructions 116 may cause the server computer 108 to apply each trained model to use current (e.g., real-time) operational signals generated by the field sensors and/or current prediction signals generated by other trained models to predict current conditions (e.g., behavior, warnings, states, etc.) of associated assets.

The generating instructions 118 may cause the server computer 108 to generate signals encoding current conditions predicted by trained models. These prediction signals are categorical signals that convey current conditions with timestamps. The generating instructions 118 may also cause the server computer 108 to generate signals encoding signal patterns characterizing the current conditions. These prediction signals are continuous signals. Example models are described in U.S. Pat. No. 10,409,926, titled “Learning Expected Operational Behavior of Machines from Generic Definitions and Past Behavior” and issued Sep. 10, 2019.

The analyzing instructions 118 may cause the server computer 108 to generate performance/status reports. In an embodiment, at least the analyzing instructions 118 may form the basis of a computational performance model. A performance/status report may include an explanation score and contribution rank of each signal of input signals used by a trained model. The explanation score describes a contribution of each signal of input signals for a predicted condition of an associated asset. The contribution rank, based on the explanation score, rank the signal among the other input signals in terms of contribution to the predicted condition. Signals higher in the rank are likely contributors for the condition of the associated asset. Example methods of determining explanation scores and contribution ranks are described in co-pending U.S. patent application Ser. No. 15/906,702, titled “System and Method for Explanation for Condition Predictions in Complex Systems” and filed Feb. 27, 2018.

The visualizing instructions 120 may cause the server computer 108 to receive a user request (API request), from a requesting client computer, to view processed data and/or signal data and, in response, cause the requesting client computer to display the processed data and/or signal data. Processed data may include performance/status reports and other information related to a model chain. Signal data may include past and current operational signals, and past and current prediction signals. For example, via an interactive graphical user interface (GUI), a user is able to investigate system errors and/or to visualize signals.

Example methods of visualizing signals are described in co-pending U.S. patent application Ser. No. 16/939,568, titled “Fluid and Resolution-Friendly View of Large Volumes of Time Series Data” and filed Jul. 27, 2020.

In an embodiment, the computer system 100 comprises components that are implemented at least partially by hardware at one or more computing devices, such as one or more hardware processors executing program instructions stored in one or more memories for performing the functions that are described herein. All functions described herein are intended to indicate operations that are performed using programming in a special-purpose computer or general-purpose computer, in various embodiments. A “computer” may be one or more physical computers, virtual computers, and/or computing devices. As an example, a computer may be one or more server computers, cloud-based computers, cloud-based cluster of computers, docker containers, virtual machine instances or virtual machine computing elements such as virtual processors, storage and memory, data centers, storage devices, desktop computers, laptop computers, mobile devices, and/or any other special-purpose computing devices. Any reference to “a computer” herein may mean one or more computers, unless expressly stated otherwise.

Computer executable instructions described herein may be in machine executable code in the instruction set of a central processing unit (CPU) and may have been compiled based upon source code written in JAVA, C, C++, OBJECTIVE-C, or any other human-readable programming language or environment, alone or in combination with scripts in JAVASCRIPT, other scripting languages and other programming source text. In another embodiment, the programmed instructions also may represent one or more files or projects of source code that are digitally stored in a mass storage device such as non-volatile RAM or disk storage, in the systems of FIG. 1 or a separate repository system, which when compiled or interpreted cause generating executable instructions which when executed cause the computer to perform the functions or operations that are described herein with reference to those instructions. In other words, the FIG. 1 may represent the manner in which programmers or software developers organize and arrange source code for later compilation into an executable, or interpretation into bytecode or the equivalent, for execution by computer(s).

The data repository 130, coupled directly or indirectly with the server computer 108, may include a database (e.g., a relational database, object database, post-relational database), a file system, and/or any other suitable type of storage system. The data repository 130 may store operational data generated by field sensors, predicted data generated by one or more trained models, processed data, and configuration data.

One or more field sensors 106 may detect or measure one or more properties of a machine, device, or equipment as operational data during operation of the machine, device, or equipment. An example machine, device, or equipment is a windmill, a compressor, an articulated robot, an IoT device, or other machinery. Operational data can also comprise condition or state indicators of each physical asset, from which condition or state indicators of each logical asset can be determined. (“State,” “condition,” “state indicator,” and “condition indicator” can be used interchangeably to refer to a value that represents or describes the state or condition of an asset.) Operational data may be transmitted via a computing device with a network communication interface or to the server computer 108 over the network 102 or directly provided to the server 108 via physical cables, for storage in the data repository 130 and for processing by trained models. Predicted data generated by the trained models may be stored in the data repository 130. In an embodiment, operational data (e.g., operational signals) and predicted data (e.g., prediction signals) may be stored in the data repository according to a particular data structure that allows the processed data to be served and/or read as quickly as possible. Example methods of storing signals are described in co-pending U.S. patent application Ser. No. 16/939,568, titled “Fluid and Resolution-Friendly View of Large Volumes of Time Series Data” and filed Jul. 27, 2020.

Processed data, such as performance/status reports, are also stored in the data repository 130. A performance/status report generally indicates how an asset performs over a period of time. A performance/status report can include a contribution score, for a signal, that indicates its contribution to an asset's condition at a certain point during the period of time that is determined by a trained model which takes that signal as input.

Configuration data associated with the trained models are also stored in the data repository 130. Configuration data include parameters, constraints, objectives, and settings of each trained or tuned model.

The data repository 130 may store other data, such as map data, that may be used by the server computer 108. Map data include geo-spatial maps where a condition indicator of an asset is mapped to the physical location of the asset that may be visualized with processed data.

The network 102 broadly represents a combination of one or more wireless or wired networks, such as local area networks (LANs), wide area networks (WANs), metropolitan area networks (MANs), global interconnected internetworks, such as the public internet, or a combination thereof. Each such network may use or execute stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein may be configured to connect to the network 102 and the disclosure presumes that all elements of FIG. 1 are communicatively coupled via the network 102. The various elements depicted in FIG. 1 may also communicate with each other via direct communications links that are not depicted in FIG. 1 for purposes of explanation.

The server computer 108 is accessible over network 102 by multiple requesting computing devices, such as the client computer 104. Any other number of client computers 104 may be registered with the server computer 108 at any given time. Thus, the elements in FIG. 1 are intended to represent one workable embodiment but are not intended to constrain or limit the number of elements that could be used in other embodiments.

A requesting computing device, such as the client computer 104, may comprise a desktop computer, laptop computer, tablet computer, smartphone, or any other type of computing device that allows access to the server computer 108. The client computer 104 may be used to request and to view or visualize processed data.

For example, the client computer 104 may send a user request to create a model of models and/or to view processed data to the server computer 108. A browser or a client application on the client computer 104 may receive response data for display in an interactive GUI that allows easy viewing operations, such as zoom, pan, and select gestures, as further described herein.

### 4.0. Asset Organization Overview

Industrial systems and processes may be represented as an organization of interconnected assets and, by extension, their respective models. Patterns are detected by a model using available features from the model.

Model chaining allows users to use logical grouping of component models to build an organization of interconnected assets with their respective models. Such an organization of assets could be defined, modeled, monitored and managed at multiple levels of granularity. In an embodiment, the organization of assets may be viewed as an asset graph, in which each asset may be viewed as a node in the graph. An organization may be hierarchical, sequential, or a hybrid of both.

4.1. Hierarchical Organization

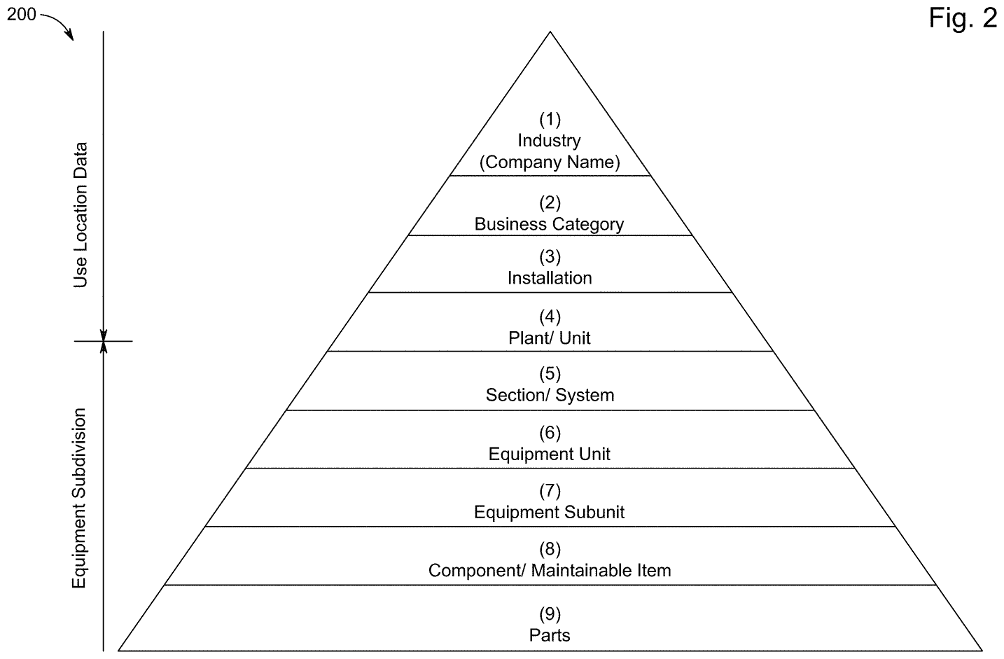

FIG. 2 illustrates an example diagram 200 showing parent-child asset relationships. The parent-child asset relationships are based on the ISO/DIS 14224 Taxonomy. The diagram 200 shows a 9-tier hierarchy of assets. An asset, such as a part, a component, an equipment subunit, an equipment, a section (also referred to as a zone), a plant, an installation, a business, or an industry, is associated with a level or tier of the hierarchy (from the bottom up).

For purposes of discussion, a simplified version of the 9-tier hierarchy is referred to herein. This simplified hierarchy starts at Level 4 (Plant) and to Level 8 (Component), and includes Level 10 (an extension to ISO/DIS 14224 taxonomy) that identifies operational signals that originate from field sensors. In this simplified hierarchy, the components (at Level 8) have one or more operational signals.

Techniques described herein are not limited to the ISO/DIS 14224 Taxonomy but rather are flexible to allow for a different taxonomy or hierarchy or even a graph structured assets.

4.1.1. Building Models

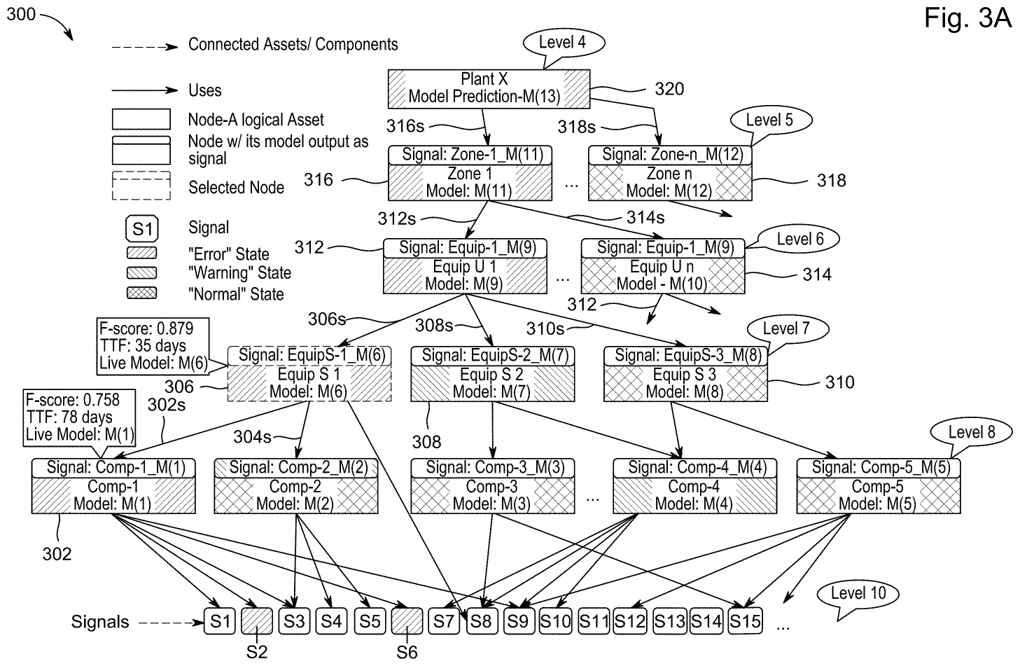

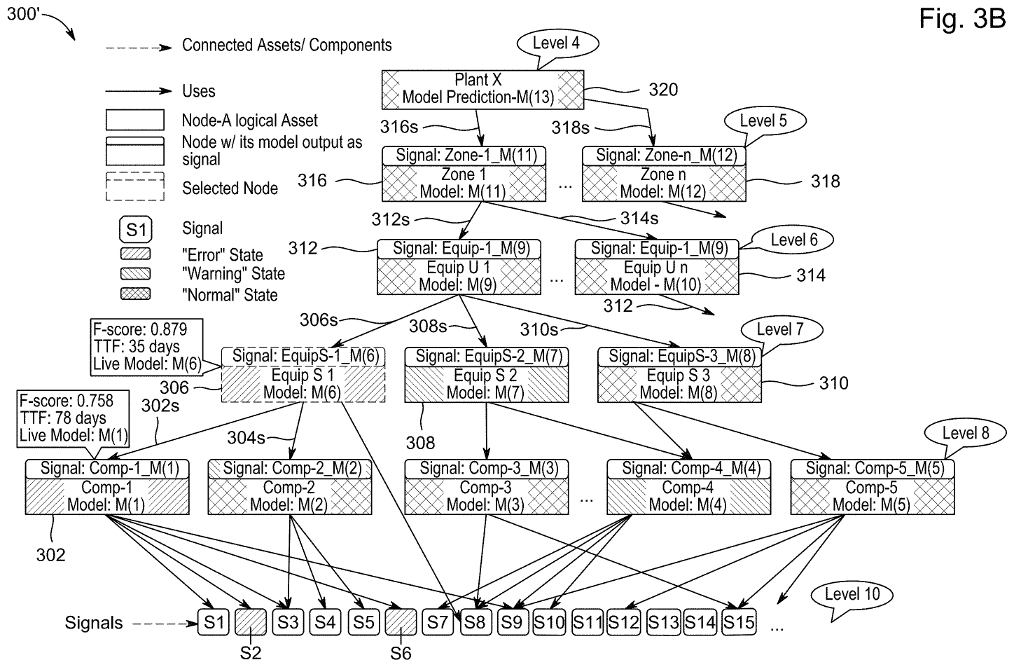

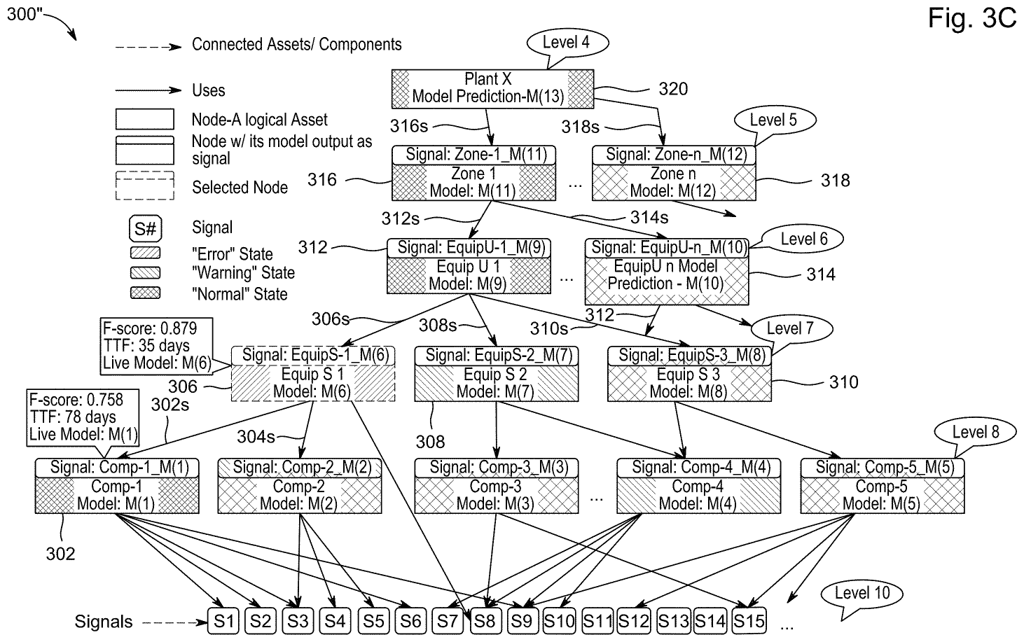

FIG. 3A illustrates an example hierarchical organization 300 of assets. The assets are associated with corresponding levels. For example, in the hierarchical organization 300, “Plant X” is a Level 4 asset; “Zone 1” and “Zone n” are Level 5 assets; “EquipU 1” and “EquipU n” are Level 6 assets; “EquipS 1,” “EquipS 2,” and “EquipS 3” are Level 7 assets; and “Comp 1,” “Comp 2,” “Comp 3,” “Comp 4,” and “Comp 5” are Level 8 assets. Operational signals S1-S15, generated by field sensors, correspond to Level 10.

Each asset is a logical asset that is represented by one or more signals (e.g., one or more sensor signals and/or one or more prediction signals). The logical relationship does not need to correspond to a physical relationship. A logical asset could correspond to a grouping of any physical assets (or other logical assets) or the conditions thereof without requiring any relationships among the physical assets in the group. For example, the “Comp 1” asset 302 is represented by five sensor signals (i.e., {S1, S2, S3, S6, S9}). For another example, the “EquipS 1” asset 306 is represented by two component prediction signals and one sensor signal (i.e., {Comp-1_M[1] 302s, Comp-2_M[2] 304s, S8}). For yet another example, the “EquipU 1” asset 310 is represented by three equipment subunit prediction signals (i.e., {EquipS-1_M[6] 306s, EquipS-2_M[7] 308s, EquipS-3_M[8] 3105}. In an embodiment, these logical assets may be defined using Signal Groups, as shown in Table B.

Each logical asset is associated with a respective model that is programmed to make an inference of conditions associated with the asset, as further described below. For example, the “Comp 1” asset 302 is associated with model M[1]. For another example, the “Plant X” asset 320 is associated with model M[13]. Each model receives and processes one or more signals, from a lower level, as input data and generates output data that includes conditions, predicted for the associated asset, that may be used by a model in an upper level. In building a model, a signal input to the model may be an operational signal generated by a sensor or an actual condition prediction signal (or indicator) of a lower-level asset. For example, all the input signals and corresponding output signals used for training purposes can be obtained from monitoring and recording actual conditions of each component or unit of the system over a period of time. For a logical asset that does not correspond to an actual physical component but merely a logical grouping of physical components that are not fully physically connected, the condition could be specifically derived according to specific rules. Patterns or other data characterizing a condition are needed to build a model, whether to classify the combination of input signals or to form part of input data for the model, the patterns or other data could be derived from the actual historical data for training purposes. The input data to a model includes those signals that represent the logical asset corresponding to the model.

In an embodiment, models are built separately. In an embodiment, models are built using a bottom up approach in the sense that the output signals associated with lower-level components are input signals of higher-level components. Referring to the example hierarchical organization 300 of FIG. 3A, models can be built at the component level (i.e., Level 8) using operational signals from the field. When a model, such as M[1] for the “Comp 1” asset 302, is built using signals (i.e., {S1, S2, S3, S6, S9}), each of these signals may be tagged with (Output) Signal Group “_m1” or equivalent that correctly identifies the model these signals belong to. Further, a similar entry will also be made in the “Model Used” field with the model identifier, such as M[1] or equivalent.

Table B shows example mappings of signals to signal groups to logical assets. These mappings correspond to the example hierarchical organization 300 of assets illustrated in FIG. 3A.

TABLE B

| Logical | | | | | |
|---|---|---|---|---|---|
| Asset | | Asset | | Model | |
| Name | Signal Name | Level | Signal Group Name | Used | Analyzer |
| Plant X | | Level 4 | | M[13] | A[13] |
| Zone 1 | Zone-1_M[11] | Level 5 | _plantx, _m[13] | M[11] | A[11] |
| Zone n | Zone-n_M[12] | Level 5 | _plantx, _m[13] | M[12] | A[12] |
| EquipU 1 | Equip-1_M[9] | Level 6 | _zone1, _m[11] | M[9] | A[9] |
| EquipU n | Equip-n_M[10] | Level 6 | _zone1, _m[11] | M[10] | A[10] |
| EquipS 1 | EquipS-1_M[6] | Level 7 | _equipu-1, _m[9] | M[6] | A[6] |
| EquipS 2 | EquipS-2_M[7] | Level 7 | _equipu-1, _m[9] | M[7] | A[7] |
| EquipS 3 | EquipS-3_M[8] | Level 7 | _equipu-1, _m[9] | M[8] | A[8] |
| Comp 1 | Comp-1_M[1] | Level 8 | _equips1, _m[6] | M[1] | A[1] |
| Comp 2 | Comp-2_M[2] | Level 8 | _equips1, _m[6] | M[2] | A[2] |
| Comp 3 | Comp-3_M[3] | Level 8 | _equips2, _m[7] | M[3] | A[3] |
| Comp 4 | Comp-4_M[4] | Level 8 | _equips2, _m[7] | M[4] | A[4] |
| Comp 5 | Comp-5_M[5] | Level 8 | _equips3, _m[8] | M[5] | A[5] |
| | S1 | Level 10 | _comp1, _m[1] | M[1] | |
| | S2 | Level 10 | _comp1, _m[1] | M[1] | |
| | S3 | Level 10 | _comp1, _m[1], | M[1], | |
| | | | _comp2, _m[2] | M[2] | |
| | S4 | Level 10 | _comp2, _m[2] | M[2] | |
| | S5 | Level 10 | _comp2, _m[2] | M[2] | |
| | S6 | Level 10 | _comp1, _m[1] | M[1] | |
| | S7 | Level 10 | _comp7, _m[4] | M[4] | |
| | S8 | Level 10 | _equips1, _m[6], | M[3], | |
| | | | _comp3, _m[3], | M[4], | |
| | | | _comp7, _m[4] | M[6] | |
| | S9 | Level 10 | _comp1, _m[1], | M[1], | |
| | | | _comp7, _m[4], | M[4], | |
| | | | _comp5, _m[5] | M[5] | |
| | S10 | Level 10 | _comp7, _m[4] | M[4] | |
| | S11 | Level 10 | | | |
| | S12 | Level 10 | _comp5, _m[5] | M[5] | |
| | S13 | Level 10 | | | |
| | S14 | Level 10 | | | |
| | S15 | Level 10 | _comp3, _m[3], | M[3], | |
| | | | _comp5, _m[5] | M[5] | |

In an embodiment, the “Model Used” field shown in Table B is for system-use only. This field ensures that the model for signal mapping is never lost. As a signal gets used in multiple models, additional model identifiers are appended to this field in a comma-separated list. Techniques described herein are further extensible to include models across different Datastreams.

In FIG. 3A, “Plant X” asset 320 is a Level 4 asset. In this example, the model output of M[13] (associated with “Plant X” 320) is not used as an input signal to any higher-level asset. As such, the entry for “Plant X” 320 does not have any Signal Group assigned and the “Signal Group Name” column is empty, as shown in Table B. In Table B, each value representing a model associated with a component in the “Signal Group Name” column is preceded with the name of the component. For example, “_m[13]” is preceded by “_plantx”. Other naming conventions are possible.

It is noted that entries for sensor signals do not have values for the “Logical Asset Name” field in Table B.

Once an organization of models is created, the models are trained (and re-trained) using actual historical data. Training a model involves providing a mathematical algorithm with sufficient historical data to learn from. A model may be retrained with new data when, for example, there is a model drift, a decline in model performance or a new condition of interest appears.

4.1.2. Applying Models in Real Time

Once models are available and new data is received by the server computer 108, the models are applied on the new data to generate new predictions/outputs. It would be tedious and time consuming to make the user apply individual models on the new data. Using an understanding of the model hierarchy as is demonstrated in Table B, the server computer 108 easily automates the apply process using deep apply. In deep apply, the server computer 108 uses the Signal Groups and/or Models Used information, as necessary, to determine the structure of the asset organization and to apply the lower-level models on the new data to generate the new outputs that are required by the higher-level models.

When the models are applied, real-time signals are routed to each model where they are used, new output is generated (at the assessment rate of the model) and routed as a signal feed to the higher-level models in real-time for pattern detection at each level, one level at a time. This roll-up continues all the way to the topmost level (e.g., plant level) for real-time analysis. In this manner, signal patterns “bubble” or propagate up from the bottom. When an abnormal event is detected at a Component level, for instance, it may contribute to the overall health of the higher-level asset(s) and performance.

For example, in FIG. 3A, given current signals {S1, S2, S3, S6, S9,}, model M[1] had predicted that “Comp 1” 302 is currently in an “Error” state. Given current signals {Comp-1_M[1] 302s, Comp-2_M[2] 304s, S8}, model M[6] had predicted that “EquipS 1” 306 is currently in an “Error” state. Given current signals {EquipS-1_M[6] 306s, EquipS-2_M[7] 308s, EquipS-3_M[8] 310a}, model M[9] had predicted that “EquipU 1” 312 is currently in an “Error” state. Given current signals {EquipU-1_M[9] 312a, EquipU-n_M[10]} 314a, model M[11] had predicted that “Zone 1” 316 is currently in an “Error” state. Given current signals {Zone-1_M[11] 316s, Zone-n_M[12] 318s}, model M[13] had predicted that “Plant X” 320 is currently in an “Error” state.

FIG. 3A illustrates a scenario when an error condition detected at the level of individual signal(s) bubbles up to the topmost level (e.g., the plant level). However, FIG. 3B illustrates another scenario when an error condition detected at the level of individual signal(s) does not bubble up to the top at the plant level of the hierarchical organization 300′. Techniques described herein allow complex systems to raise fewer and pointed alerts based on the patterns detected either at the lower-level component model or pattern of patterns in the higher-level composite models. This is advantageous in complex industrial systems, where a crew is responsible for managing the state of the system and running smooth operations at all times. When something goes wrong, rather than raising thousands of alerts, which may overwhelm end-users and cause end-users to miss a critical alert, propagation of an error stops at a certain level given the patterns detected in a model, as illustrated in FIG. 3B.

In FIG. 3B, the error condition detected at the level of the individual signal(s) caused the “Comp 1” asset to go into an “Error” state. The error rippled into the “EquipS 1” asset, but the propagation stopped here as model M[9] had predicted that “EquipU 1” asset is currently in a “Normal” state, despite the predicted error condition of “EquipS 1” asset. This may be because the signal(s) from the “EquipS 3” asset may have a higher contribution to the state of the “EquipU 1” asset and, therefore, the “EquipU 1” asset is shown as being in a “Normal” state, as further discussed below.

Managing system operation in a hierarchical manner, including propagating errors up only when the models associated with assets at a certain level of a hierarchy have outputted an error condition, provide an advantage and improvement over prior monitoring and alerting systems for users in a manner that allows them to stay focused on a particular problem at hand without being distracted or overwhelmed with unwanted false-positive alerts.

As a real-world illustration, an entire crude-oil processing plant would not be in an error state if one of the motors (lowest level component) becomes faulty and starts to misbehave. For an entire plant to be in an “Error” state it may require a large number of critical systems and/or subsystems to become faulty.

While an error condition may be detected at the level of individual signal(s), as illustrated in FIG. 3A and FIG. 3B, a root cause may not always be a sensor signal. For example, in FIG. 3C, the combination of prediction signals {Comp-1_M[1] 302s, Comp-2_M[2] 304s} and a sensor signal {S8} could cause the system to detect an error condition at the “EquipS 1” asset.

4.1.3. Analyzing Model Performance

While building models follows a bottom-up approach, analyzing model performance follows a top-down approach. To explain the top-down approach, FIG. 3A and Table B are referenced.

In an embodiment, a performance/status report may be generated at each level that can provide a detailed view of an asset under monitoring to a user. During model performance analysis, using these reports, the user may traverse down the asset hierarchy, starting from the top (e.g., highest level) signals to find a potential root cause of the “Error” state of “Plant X” or another higher-level asset. The user may traverse down the assets by looking at the signals that most explain an error condition. The user may also traverse down the signals by looking at those signals that have high explanation scores provided by a corresponding Analyzer or a Live Model any that given a condition of a first component caused by the conditions of a group of sub-components, generates an explanation score for each of the sub-components that estimates how much the sub-component's condition contributes to the first component's condition.

For example, the user may look at explanation scores for the input signals for the current condition of “Plant X” 320, which would lead to predicted signals {Zone-1_M[11] 316s, Zone-n_M[12] 318s} used in model M[13]. The user may find a comparatively high explanation score for signal Zone-1_M[11] 316s. In other words, the condition observed at “Plant X” 320 is best explained by the condition of “Zone 1” 316. At this point, the user has a lead and may navigate to model M[11] for “Zone 1” 316.

“Zone 1” 316, which is a logical asset, is in an “Error” state, uses signals from models of the two equipment units (i.e., {EquipU 1 312, EquipU n 314}). Condition of “Zone 1” 316 are explained by one or more of its constituent signals, namely {EquipU-1_M[9] 312s, EquipU-n_M[10] 314s}, which are outputs of models M[9] and M[10]. When looking at the explanation scores and signal contribution rank for these signals, the user may find that the current state of “Zone 1” 316 is best explained by the signal EquipU-1_M[9] 312s. This will lead the user to further investigate “EquipU 1” 312 for more details.

“EquipU 1” 312, which is a logical asset, is in an “Error” state, and uses outputs from three equipment subunits (i.e., {EquipS 1 306, EquipS 2 308, EquipS 3 310}). The user may find a high explanation score for signal EquipS-1_M[6] 306s; a medium explanation score for signal EquipS-2_M[7] 308s; and, finally, a low explanation score for signal EquipS-3_M[8] 310s. This will guide the user towards understanding the behavior of “EquipS 1” 306, where the explanation score is high. Condition of “EquipU 1” 312 will be explained by one or more of its constituent signals, namely {EquipS-1_M[6] 306s, EquipS-2_M[7] 308s, EquipS-3_M[8] 310s}.

The same analysis continues, showing that the “Error” state of “EquipS 1” 306 may be better explained by the high explanation score for signal Comp-1_M[1] 302s, which in turn would point to signals {S2, S6}, which may have a higher explanation score.

In an embodiment, the user may be able to backtrack to traverse a different signal path to investigate another potential root cause for the “Error” state predicted by model M[13]. For example, from “Comp 1,” the user may backtrack to “EquipU 1” to investigate “EquipU 2” or “EquipU 3” for more details and then, from there, to traverse down the signals. The backtracking could follow a ranking of the components in terms of their explanation scores. For example, as discussed above, when “EquipU 1” generates the signal with the highest explanation score, it can be inspected first. When it is at least desirable to inspect another component that contributes to the condition of “Zone 1,” the component that generates the next highest explanation score can be inspected.

In some embodiments, the component associated with the highest explanation score may not be predicted to be in an error state, following the sub-hierarchy rooted at this component might not lead to components predicted to be in error states, or manually inspecting the component might not reveal an error. Though there is no requirement that an “error” condition at higher levels comes from an “error” condition at a lower level, as illustrated in FIG. 3C, there are instances when backtracking could be helpful. The need to backtrack could also trigger a rebuild of the prediction model associated with the component from which backtracking is performed, such as “EquipU 1,” or the parent component, such as “Zone 1,” or the explanation method associated with the parent component. When these models or methods are outdated or otherwise function incorrectly, a straightforward top-down analysis might not be possible. The rebuild could incorporate the result of a manual inspection as input data or more recent actual conditions of the components, for example.

In some embodiments, multiple paths in the hierarchy can be traversed at the same time. All paths corresponding to the top N (a positive integer) explanation scores or all explanation scores above a certain threshold could be traversed. The decision on whether to traverse a path can also depend on both the explanation score associated with a component and the current state of the component. For example, the list of possible conditions could be converted into condition scores, such as a largest number for an error state and a smallest number for a normal state. The decision could then be based on the product of the explanation score and the condition score. In other embodiments, the decision could be based on a manual inspection of the asset when the asset corresponds to a physical asset. For example, a path leading to a component may not be traversed when in reality the component is in a normal condition. In this manner, the analysis is guiding the manual inspection of physical components at select levels of the hierarchy in diagnosing a problem.

4.2. Sequential Organization

4.2.1. Oil Processing Plant Example

In many industrial setups, it may be beneficial to see a complex system, such as an oil processing plant, sequentially instead of hierarchically (like above). At a very high level, the oil processing plant puts crude oil through a chemical process that is composed of three steps: {Separation, Conversion, Treatment}. While the hierarchical nature applies to the structure of the system operation, the sequential nature generally applies to the timing of the system operation. The crude oil is taken as inputs to produce, after the three steps, multitudes of petroleum products as the output. Techniques described herein are flexible to support sequential systems or processes.

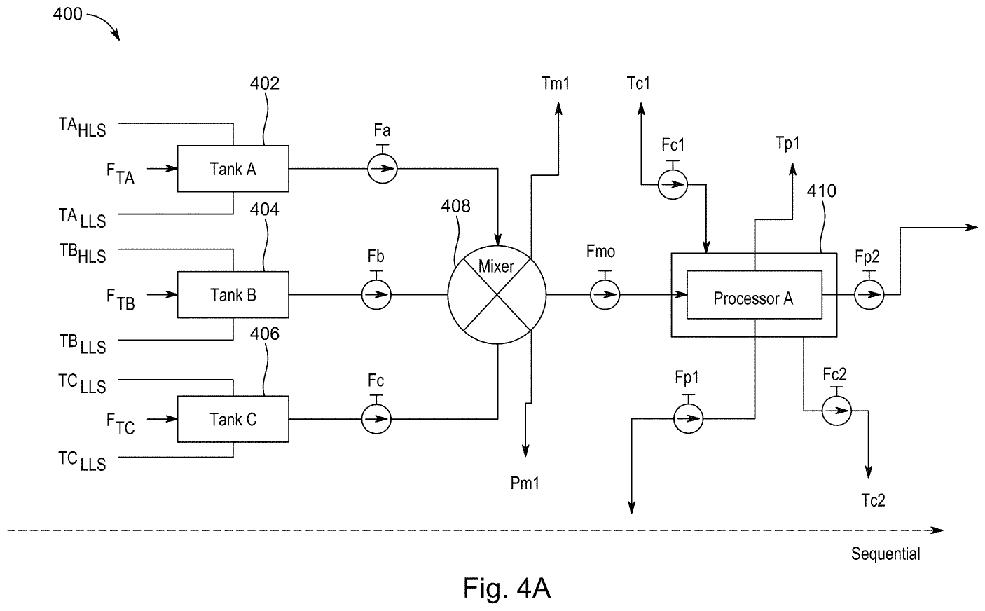

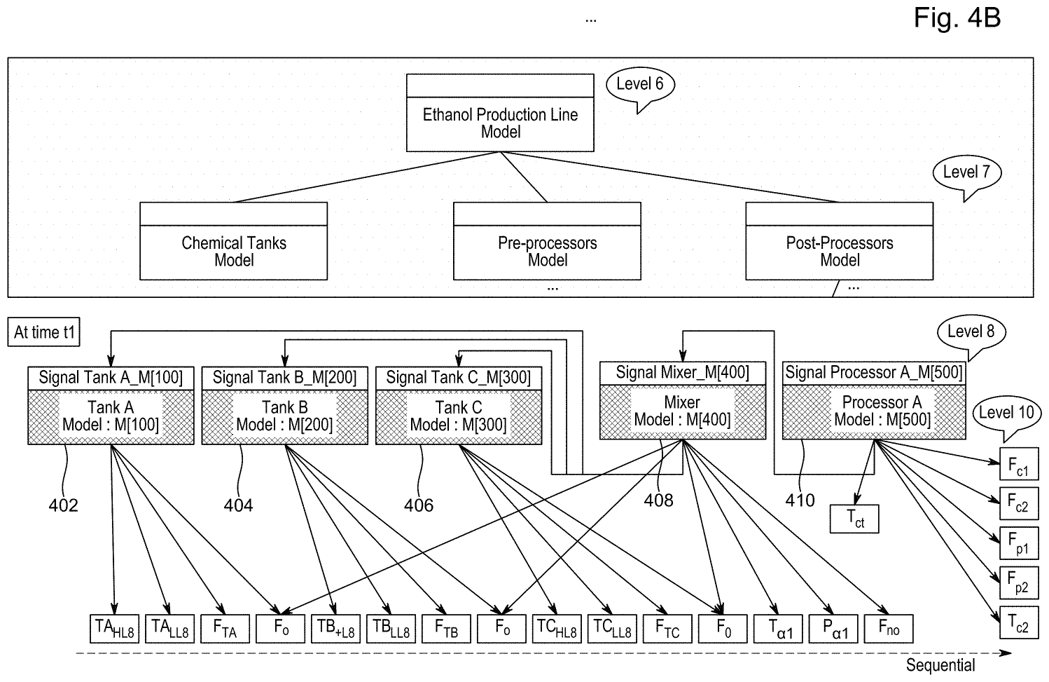

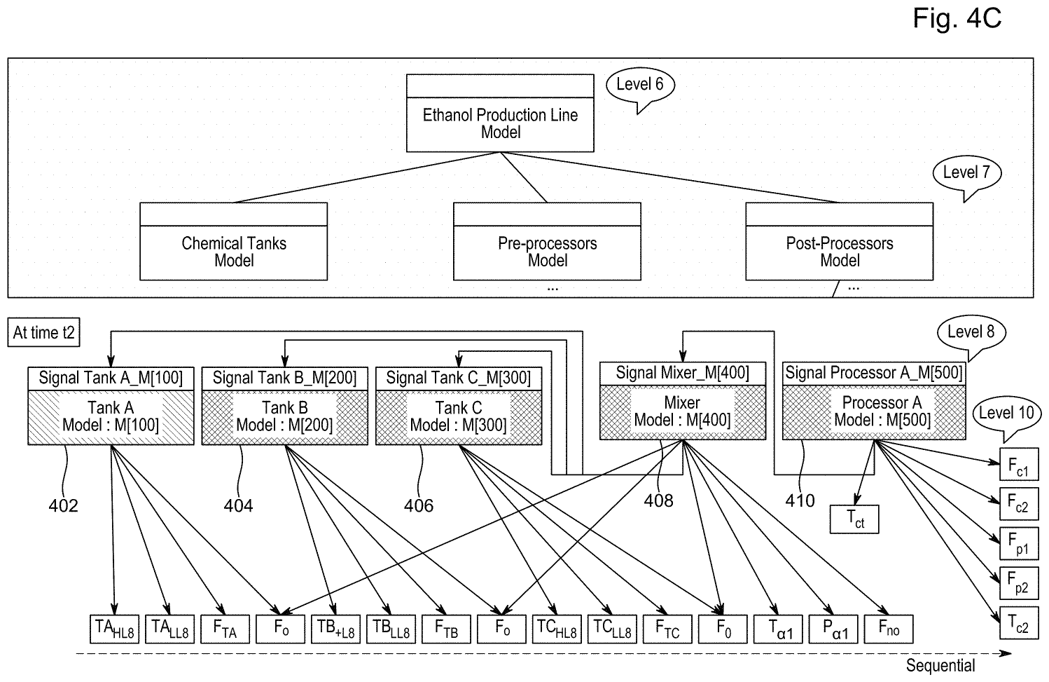

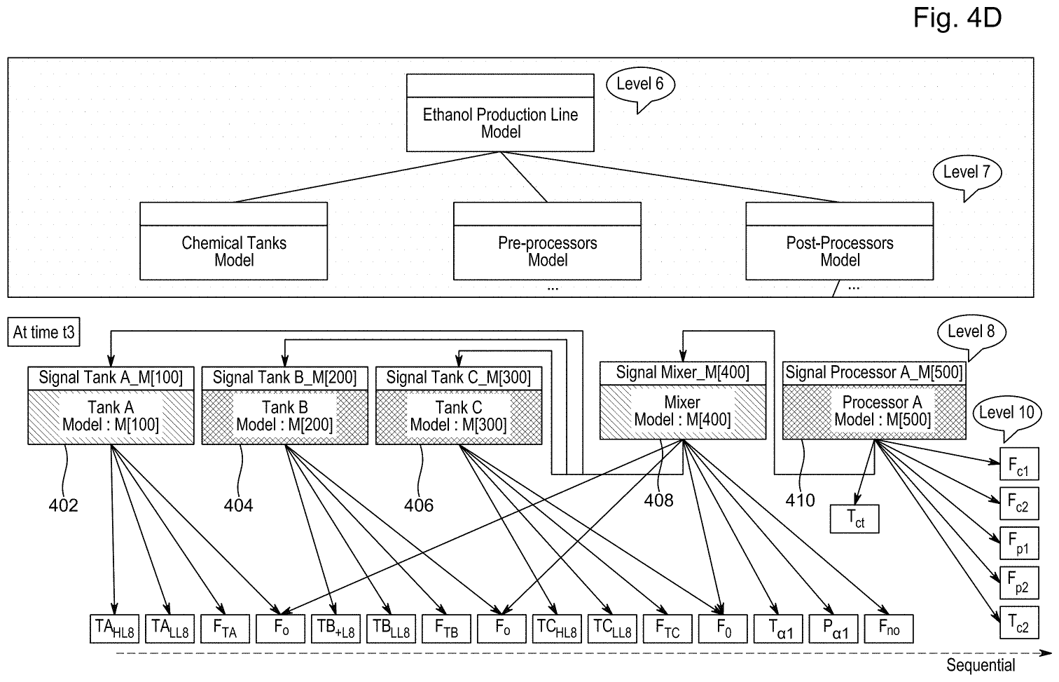

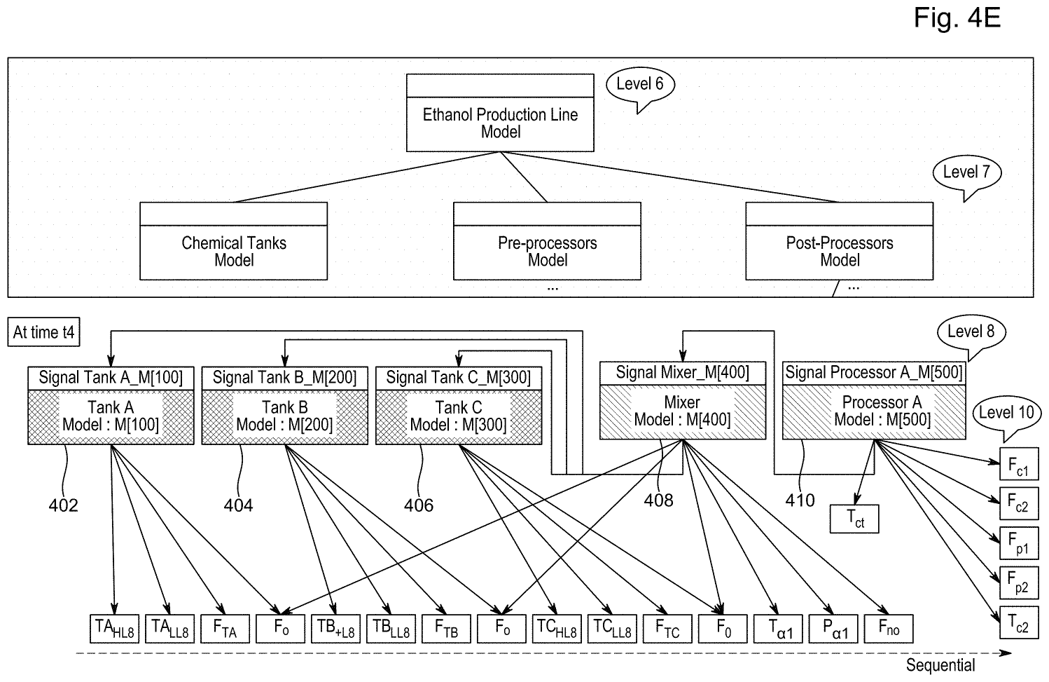

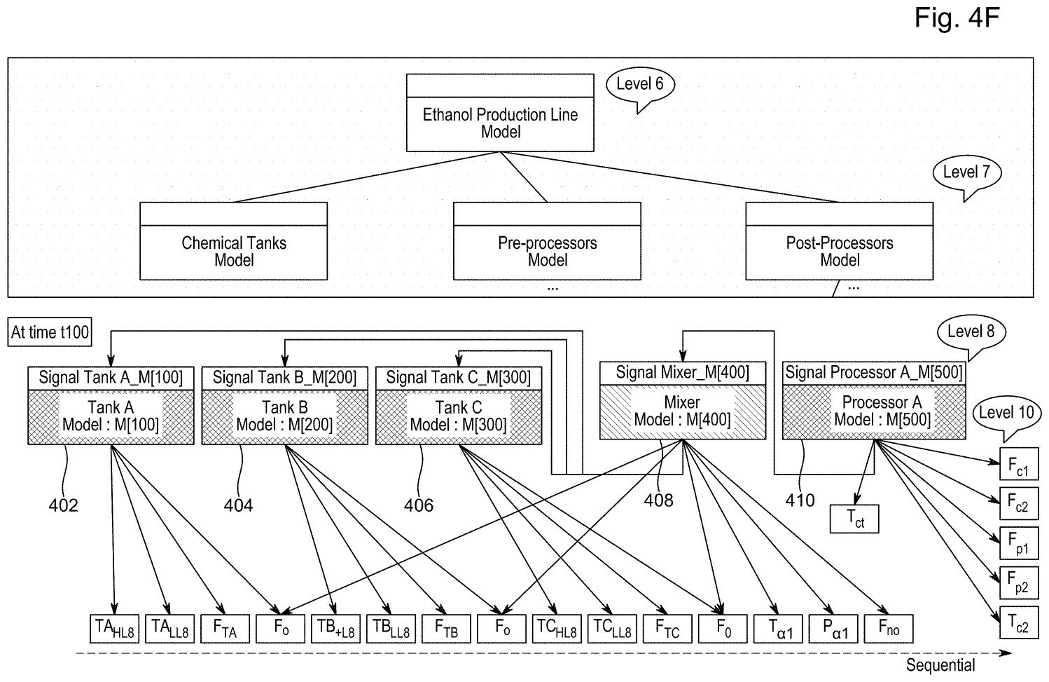

FIGS. 4A-4F illustrate an example sequential organization 400 of assets. The assets in the organization 400 are part of a chemical plant. The assets include systems “Tank A” 402, “Tank B” 404, “Tank C” 406, “Mixer” 408, and “Processor A” 410. The assets represent a sequence of systems instead of a system of systems. In this organization 400, the assets are Level 8 assets.

In FIG. 4A, the performance of the “Mixer” 408 depends upon the output it receives from the prior processing systems “Tank A” 402, “Tank B” 404, and “Tank C” 406. Any undesired performance produced in one system will affect the overall process performance and/or the quality of the product produced.

Table C shows example mappings of signals to signal groups to logical assets. These mappings correspond to the example sequential organization 400 of logical assets illustrated in FIG. 4A.

TABLE C

| Logical | | | | | |
|---|---|---|---|---|---|
| Asset | | Asset | | Model | |
| Name | Signal Name | Level | Signal Group Name | Used | Analyzer |
| Processor | ProcessorA_M | Level 8 | _output | | A[500] |
| A | [500] | | | | |
| Mixer | Mixer_M[400] | Level 8 | _processorA, _M[500] | M[500] | A[400] |
| Tank A | Tank-A_M[100] | Level 8 | _mixer, _M[400] | M[400] | A[100] |
| Tank B | Tank-B_M[200] | Level 8 | _mixer, _M[400] | M[400] | A[200] |
| Tank C | Tank-C_M[300] | Level 8 | _mixer, _M[400] | M[400] | A[300] |
| | T_{c1} | Level 10 | _processorA, _M[500] | M[500] | |
| | F_{c1} | Level 10 | _processorA, _M[500] | M[500] | |
| | Tₚ₁ | Level 10 | _processorA, _M[500] | M[500] | |
| | Fₚ₁ | Level 10 | _processorA, _M[500], | M[500] | |
| | | | _output | | |
| | F_{c2} | Level 10 | _processorA, _M[500], | M[500] | |
| | | | _output | | |
| | Fₚ₂ | Level 10 | _processorA, _M[500], | M[500] | |
| | | | _output | | |
| | T_{c2} | Level 10 | _processorA, _M[500], | M[500] | |
| | | | _output | | |
| | Fₘₒ | Level 10 | _processorA, | M[400], | |
| | | | _M[500],_mixer, | M[500] | |
| | | | _M[400], | | |
| | Tₘ₁ | Level 10 | _mixer, _M[400] | M[400] | |
| | Pₘ₁ | Level 10 | _mixer, _M[400] | M[400] | |
| | Fₐ | Level 10 | _mixer, _tankA, | M[100], | |
| | | | _M[100], _M[400] | M[400] | |
| | F_{b} | Level 10 | _mixer, _tankB, | M[200], | |
| | | | _M[200], _M[400] | M[400] | |
| | F_{c} | Level 10 | _mixer, _tankC, | M[300], | |
| | | | _M[300], _M[400] | M[400] | |
| | TA_{HLS} | Level 10 | _tankA, _M[100] | M[100] | |
| | F_{TA} | Level 10 | _tankA, _M[100] | M[100] | |
| | TA_{LLS} | Level 10 | _tankA, _M[100] | M[100] | |
| | TB_{HLS} | Level 10 | _tankB, _M[200] | M[200] | |
| | F_{TB} | Level 10 | _tankB, _M[200] | M[200] | |
| | TB_{LLS} | Level 10 | _tankB, _M[200] | M[200] | |
| | TC_{HLS} | Level 10 | _tankC, _M[300] | M[300] | |
| | F_{TC} | Level 10 | _tankC, _M[300] | M[300] | |
| | TC_{LLS} | Level 10 | _tankC, _M[300] | M[300] | |

Each system in the organization 400 of FIG. 4A and Table C can be modeled using the techniques described herein. As an example, during model application, based Table C, “Tank A” uses M[100], which inputs three signals {TA_{HLS}, F_{TA}, TA_{LLS},} and outputs one signal {Fₐ}, where:
TA_{HLS} is Tank A High-Level Sensor,
TA_{LLS} is Tank A Low-Level Sensor,
F_{TA} is input flow for “Tank A,”
Fₐ is output flow for “Tank A,” and
M[100] is the condition output for “Tank A.”

The patterns detected in the discrete model M[100] may be representative of the quality of the output produced from “Tank A” 402. The output signal may also be considered as a signal for modeling. The approach for modeling “Tank A” 402 is similar to modeling “Tank B” 404 and “Tank C” 406 generating the condition outputs from discrete models M[200] & M[300] respectively.

Further downstream inputs to “Mixer” 408 are:

1. output flow data (e.g. rate and velocity) of each tank {Fₐ, F_{b}, F_{c}} into “Mixer,”

2. two of its own sensor readings {Tₘ₁, Pₘ₁}, and

3. the time shifted condition output of each of the tanks {M[100], M[200], M[300]},

where
Fₐ is output flow for “Tank A,”
F_{b} is output flow for “Tank B,”
F_{c} is output flow for “Tank C,”
Tₘ₁ is a Temperature sensor at “Mixer,” and
Pₘ₁ is a Pressure sensor at “Mixer.”
   This will generate a condition output from the “Mixer” 408 (in addition to the flow output from {Fₘₒ}) whose quality is represented by patterns detected in composite model M[400].

Similarly, the learning signals for a composite model M[500] of “Processor A” 410 are {Fₘₒ, T_{c1}, T_{c2}, F_{c1}, F_{c2}, Tₚ₁, Fₚ₁, Fₚ₂, time shifted Mixer conditions [M400 output]}, where:
T_{c1} is input coolant temperature,
T_{c2} is output coolant temperature,
F_{c1} is input coolant flow,
F_{c2} is output coolant flow,
T_{P1} is a Temperature sensor inside the “Processor A,”
F_{P1} is output flow of product 1 (P1), and
F_{P2} is output flow of product 2 (P2).

FIGS. 4B-4F depict a hypothetical scenario of the sequential organization of assets 400 at different times. FIGS. 4B-4F also show the assets and their corresponding models.

FIG. 4B illustrates the sequential organization 400 at time t1, where
Tank-A_M[100] is a prediction signal of “Tank A,”
Tank-B_M[200] is a prediction signal of “Tank B,”
Tank-C_M[300] is a prediction signal of “Tank C,”
Mixer_M[400] is a prediction signal of “Mixer,” and
Processor-A_M[500] is a prediction signal of “Processor A.”

At time t2, as illustrated in FIG. 4C, the flow {F_{TA}} drops causing the chemical levels in “Tank A” to fall below a low level mark. This results in a reduced flow {Fₐ} going into the “Mixer” as well as a new condition in the Tank A prediction signal M[100]. The chemical composition in the “Mixer” sees an imbalance resulting in, for example, increased temperature and/or pressure. This results in the “Mixer” exhibiting a warning condition at time t3, as illustrated in FIG. 4D.

The condition of the “Mixer,” at time t3, could be explained by the sensor signals {Tₘ₁, Pₘ₁, Fₐ} and the prediction signals {Tank-A_M_[100]}, while the prediction signals {Tank-B_M[200], Tank-C_M[300]} are non-contributing to the condition because nothing changed in the operation of those tanks. Thus, the Tank A_M[100] condition propagates to downstream models, helping predict and explain the behaviors of the downstream components.

Moving along, the flow of chemicals in “Tank A” is restored and is back to normal operating condition, as illustrated in FIG. 4E. However, the normal behavior takes some time to propagate to the “Mixer.” Meanwhile, the “Processor A” is exhibiting a warning condition due to the lower quality chemical mix delivered to it. This results in a batch of some bad quality output at either F_{P1}, or F_{P2} or any combination thereof.

It is possible that the “Mixer” may exhibit a different type of warning condition on its own even when “Tank A,” “Tank B,” and “Tank C” operations are normal. This could be because of its own independent set of sensor signals or may be clogging at valve {Fₘₒ} or some chemical sludge buildup inside the “Mixer.” This will result in an independent change in asset behavior, which will affect downstream, causing a high level mark reaching in one or all of the tanks. FIG. 4F illustrates the onset of such a behavior at time t100.

As in a hierarchical organization, building models and analyzing model performance in a sequential organization are performed in reverse or opposite fashion. For example, while “Tank A,” “Tank B,” “Tank C,” “Mixer,” and “Processor A” are all Level 8 assets, building models in a sequential organization follows a downstream approach (e.g., starting with “Tank A,” “Tank B,” and “Tank C”), and analyzing model performance in a sequential organization follows an upstream approach (e.g., starting with “Processor A”).

4.2.2 Automobile Manufacturing Plant Example

An automobile manufacturing plant is another example of a complex system. An end-to-end automobile manufacturing process that includes numerous parts and assembly steps, may be laid out as a sequential process. Each assembly step may be built on top of the previous assembly step, which thereby forms a product hierarchy. Monitoring assets in such a sequential organization allows a user to assess the product hierarchy of the automobile (e.g., a manufactured product. Bad quality of any of the lower-level parts in the product hierarchy will reflect on the overall quality of the automobile.

Assume that the assembly of a chassis requires numerous weldings. A bad quality weld could become a potential hazard. Using the sequential organization of the weld assets in the automobile manufacturing plant, the quality at each weld station may be determined by building a model for that weld station. Every weld station will have the state of the product at the end of the previous station and may have an independent set of inputs. This chaining continues throughout the manufacturing process. A ML model assessing the quality of work done (e.g., weld) at each step reflects the quality of the final manufactured product (e.g., automobile).

4.3. Hybrid Organization

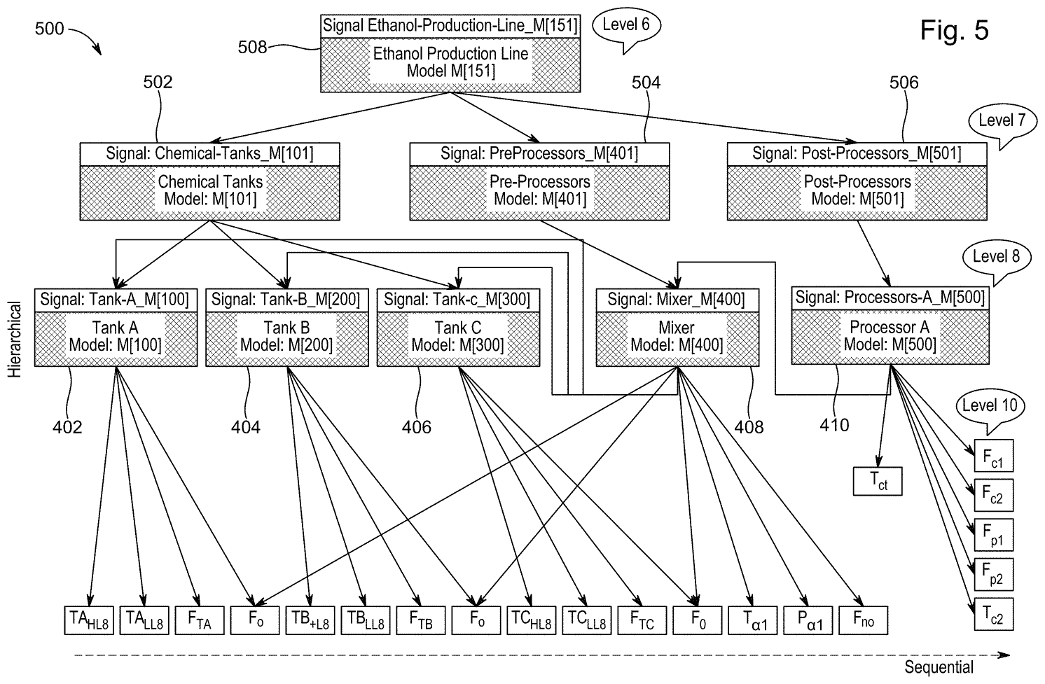

Techniques described herein are also flexible to support hybrid systems or processes. FIG. 5 illustrates an example hybrid organization 500 of assets. FIG. 5 introduces a hierarchical asset organization to the sequential asset organization 400 of FIG. 4A in the oil processing plant.

Everything at Level 8 and below remains the same as seen in the sequential organization 400. At Level 7, logical assets “Chemical Tanks” 502, “Pre-Processors” 504, and “Post-Processors” 506 are created. The “Chemical Tanks” asset 502 is represented by three prediction signals {Tank-A_M[100], Tank-B_M[200], Tank-C_M[300]} and generates prediction output under model M[101] associated with the “Chemical Tanks” asset 502. The “Pre-Processors” asset 504 is represented by one or more prediction signals {Mixer_M[400], . . . } and generates a prediction output under model M[401] associated with the “Pre-Processors” asset 504. The “Post-Processors” asset 506 is represented by one or more prediction signals {Processor-A_M[500], . . . } and generates a prediction output under model M[501] associated with the “Post-Processors” asset 506.

The logical assets “Chemical Tanks” 502, “Pre-Processors” 504, and “Post-Processors” 506 are extracted to the next higher level logical asset “Ethanol Production Line” 508, which is represented by prediction signals {Chemical-Tanks M[101], Pre-Processors M[401], Post-Processors_M[501]}. Model M[151] for this logical asset “Ethanol Production Line” 508 will look at the health of the overall line of ethanol production—a sequential process. As illustrated, the output of each model will roll-up to the next logical entity and develop a hierarchical structure.

Table D shows example mappings of signals to signal groups to logical assets. These mappings correspond to the example hybrid organization 500 of assets illustrated in FIG. 5.

TABLE D

| Logical | | Asset | | Model | |
|---|---|---|---|---|---|
| Asset Name | Signal Name | Level | Signal Group Name | Used | Analyzer |
| Ethanol | Ethanol- | Level 6 | | M[151] | A[151] |
| Production | Production- | | | | |
| Line | Line_M151] | | | | |
| Post | Post- | Level 7 | _ethanol-production- | M[151] | A[501] |
| Processors | Processors_M[501] | | line, _M[151] | | |
| Pre | Pre- | Level 7 | _ethanol-production- | M[151] | A[401] |
| Processors | Processors M[401] | | line, _M[151] | | |
| Chemical | Chemical- | Level 7 | _ethanol-production- | M[151] | A[101] |
| Tanks | Tanks_M[101] | | line, _M[151] | | |
| Processor A | ProcessorA_M[500] | Level 8 | _post-processors, | M[501] | A[500] |
| | | | _M[501], _output | | |
| Mixer | Mixer_M[400] | Level 8 | _processorA, _pre- | M[400], | A[400] |
| | | | processors, _M[500], | M[401] | |
| | | | _M[401] | | |
| Tank A | TankA_M[100] | Level 8 | _mixer, chemical- | M[400], | A[100] |
| | | | tanks, _M[400], | M[101] | |
| | | | _M[101] | | |
| Tank B | TankB_M[200] | Level 8 | _mixer, chemical- | M[400], | A[200] |
| | | | tanks, _M[400], | M[101] | |
| | | | _M[101] | | |
| Tank C | TankC_M[300] | Level 8 | _mixer, chemical - | M[400], | A[300] |
| | | | tanks, _M[400], | M[101] | |
| | | | _M[101] | | |
| | T_{c1} | Level 10 | _processorA, _M[500] | M[500] | |
| | F_{c1} | Level 10 | _processorA, _M[500] | M[500] | |
| | Tₚ₁ | Level 10 | _processorA, _M[500] | M[500] | |
| | Fₚ₂ | Level 10 | _processorA, _M[500], | M[500] | |
| | | | _output | | |
| | F_{c2} | Level 10 | _processorA, _M[500], | M[500] | |
| | | | _output | | |
| | Fₚ₂ | Level 10 | _processorA, _M[500], | M[500] | |
| | | | _output | | |
| | T_{c2} | Level 10 | _processorA, _M[500] | M[500] | |
| | Fₘₒ | Level 10 | _processorA, _mixer, | M[400], | |
| | | | _M[400], _M[500] | M[500] | |
| | Tₘ₁ | Level 10 | _mixer, _M[400] | M[400] | |
| | Pₘ₁ | Level 10 | _mixer, _M[400] | M[400] | |
| | Fₐ | Level 10 | _mixer, _tankA, | M[100], | |
| | | | _M[100], _M[400] | M[400] | |
| | F_{b} | Level 10 | _mixer, _tankB, | M[200], | |
| | | | _M[200], _M[400] | M[400] | |
| | F_{c} | Level 10 | _mixer, _tankC, | M[300], | |
| | | | _M[300], _M[400] | M[400] | |
| | TA_{HLS} | Level 10 | _tankA, _M[100] | M[100] | |
| | F_{TA} | Level 10 | _tankA, _M[100] | M[100] | |
| | TA_{LLS} | Level 10 | _tankA, _M[100] | M[100] | |
| | TB_{HLS} | Level 10 | _tankB, _M[200] | M[200] | |
| | F_{TB} | Level 10 | _tankB, _M[200] | M[200] | |
| | TB_{LLS} | Level 10 | _tankB, _M[200] | M[200] | |
| | TC_{HLS} | Level 10 | _tankC, _M[300] | M[300] | |
| | F_{TC} | Level 10 | _tankC, _M[300] | M[300] | |
| | TC_{LLS} | Level 10 | _tankC, _M[300] | M[300] | |

A user may study the impact of the system state on the quality of the output produced by comparing two or more model outputs. For example, the user may compare the Level 6 model Ethanol-Production-Line-A_M[151], which reflects the overall state of the production line, and Level 8 model Post-Processors_M[501], which reflects the overall quality of the output generated.

### 5.0. Graphical User Interface Examples

5.1. Signal Visualizations

In an embodiment, a user may select models and independently select signals of their choice in a GUI to visualize relevant signals in a timeline view.

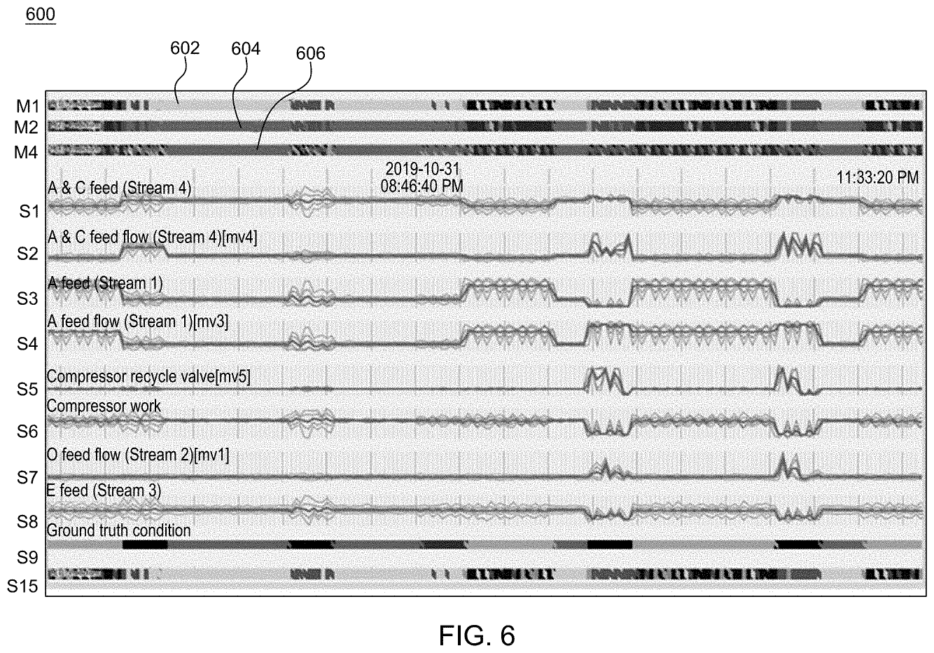

FIG. 6 illustrates an example timeline view 600 in accordance with some embodiments. The timeline view 600 enables the user to view requested signal information in a GUI. As illustrated, the user has selected to view three model outputs {M[1] 602, M[2] 604 & M[4] 606} and signals S1-S9 and S15 (corresponding to those shown in FIG. 3A) for viewing.

As described below, the GUI includes features to present signals in a new and useful manner that allows the user to determine model-signal relationships in a hierarchical context or another context that reflects the structural relationship among components of a system.

5.1.1. Signals Highlighted by Model

In an embodiment, the server computer 108 causes via a GUI initially presenting graphical representations of signals representing conditions of higher-level components, such as the entire system or the assets being hierarchically right under the entire system. The GUI allows the user to drill down to signals representing conditions of lower-level components. For example, these signals could also be displayed in a separate window or on the bottom of the screen to add to the existing display.

In some embodiments, when the user is reviewing a particular model, such as M[1] 602, the GUI highlights the graphical presentation of the associated signal. The server computer 108 uses the information in a data structure, such as Table B, to recognize that signals related to the particular model, such as {S1, S2, S3, S6 & S9}, are to be added to the view, highlighted, or grouped in a collection shown at a certain position within the view. (The “Models Used” field in Table B helps filter down the signals for display of selected models.) Other signals could fade away or may be dropped lower in the view or removed completely from the view.

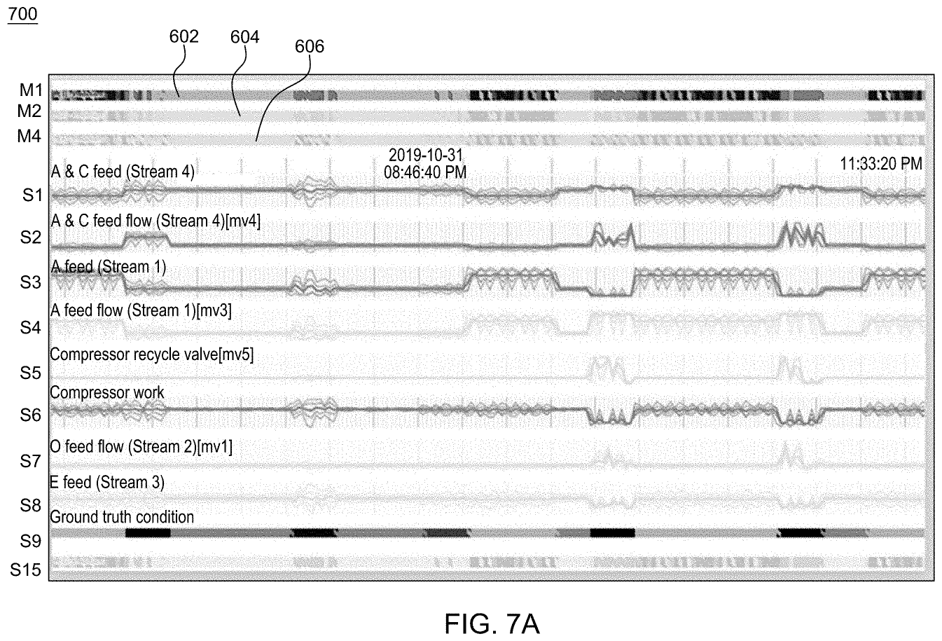

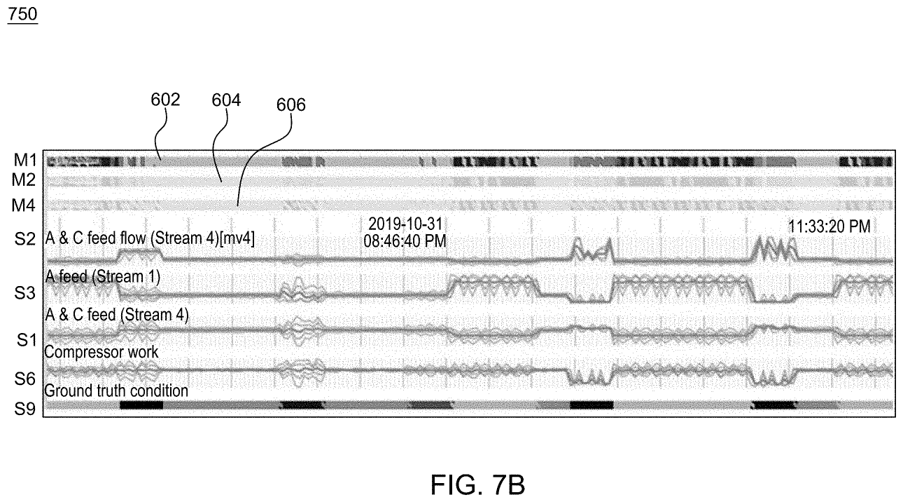

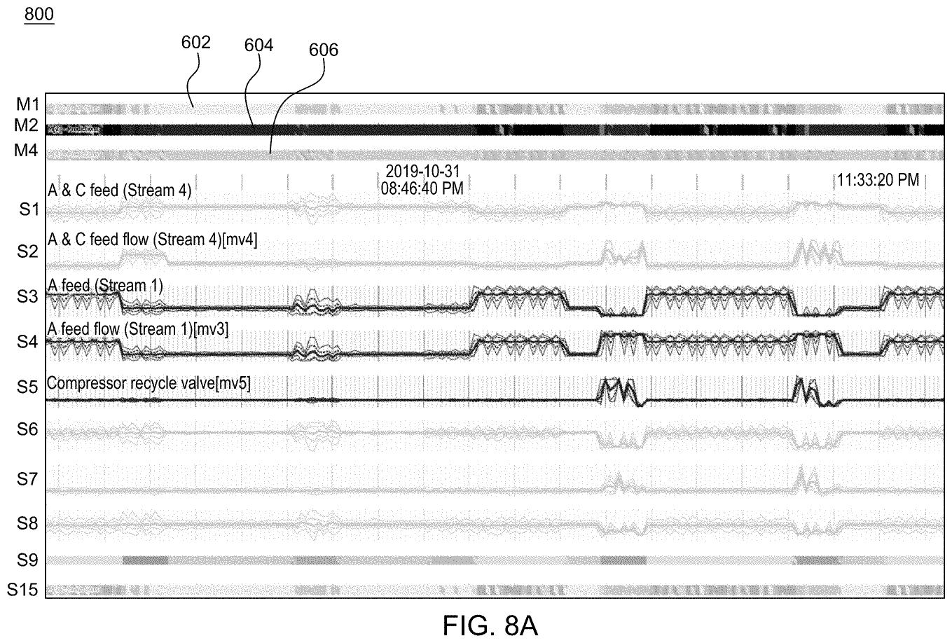

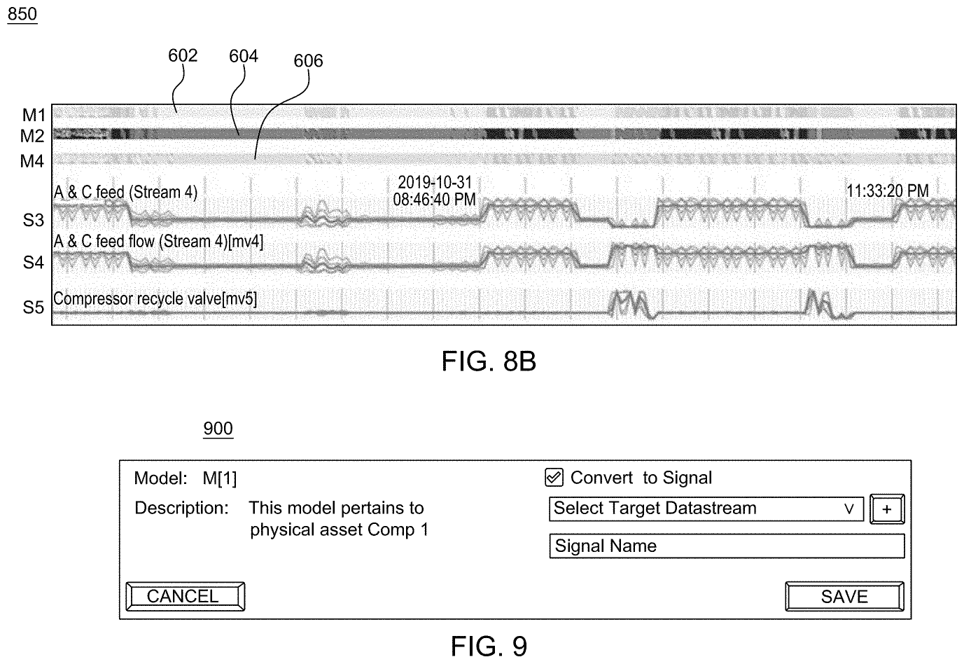

In some embodiments, the GUI initially shows graphical representations of all signals associated with specific levels of a hierarchy and highlights all the displayed signals related to a component in response to user input. As illustrated in FIG. 7, when the user is focused on model M[1] 602 and the GUI highlights only the signals that are used in model M[1] in timeline view 700. For another example, in FIG. 8A, the user is focused on model M[2] and the system highlights only the signals that are used in model M[2] in timeline view 800.

In example of FIG. 7A, M1 corresponds to a lower-level component and the signal produces categorical values that might correspond to different possible conditions of the component “Comp 1.” S1, for example, corresponds to a sensor and the signal produces sensor readings as continuous values. In other embodiments, a model corresponding to a higher-level component can also produce continuous values. As discussed above, the model could output, instead of or in addition to the estimated condition of the component, additional data that can be converted to continuous values, such as patterns characterizing the conditions.

5.1.2. Signals Grouped by Model and Sorted by Contribution Rank

In an embodiment, a signals list may be sorted in order of the signal contribution ranks (e.g., descending, ascending, etc.) to help the user focus only on those signals that matter the most for the condition/prediction of interest. The signal contribution ranks can be obtained from applying one of the explanation methods, as discussed above.

For example, in timeline view 750 of FIG. 7B, the signals used in model M[1] are displayed in descending order of the signal contribution rank for {S1, S2, S3, S6, S9}. The signal S2 is the top rank signal for model M[1], followed by S3, S1, S6, and S9. For another example, in timeline view 850 of FIG. 8B, the signals used in model M[2] are displayed in descending order of the signal contribution rank for {S3, S4, S5}. The signal S3 is the top rank signal for model M[2], followed by S4 and S5.

5.1.3. Other Example Visualization Features

Other GUI features may include a grouping feature, a linking feature, and a pinning feature. Using the grouping features, one or more signals may be grouped. Grouped signals may be shown/hidden using an expand/collapse feature. Using the linking feature, a link may be provided to “show 5 more” signals, for example. Using the pinning feature, one or more signals may be pinned to a timeline view and may always be shown on top of the timeline view. In this manner, every time a new signal is pinned, it may be automatically added to the “pinned” group so that the signal does not hide away and is moved to the top portion of the timeline view.

In an embodiment, displayed signals may be reorganized on the GUI based on a selected event (e.g., behavior) in the GUI. In an embodiment, a signal may be zoomed in/out on the timeline view.

5.2. Model to Signal Conversion

As described herein, a model of models may represent either a higher-level physical or logical asset. FIG. 9 illustrates an example GUI 900 of converting a model output to a signal in accordance with some embodiments. Via the GUI 900, a user may pick a model whose output that they want to use as a signal, specifically an input signal for another model. The user may identify a target Datastream that represents a stream or pool of data items, where the signal will be available for further processing, such as being used as an input signal by another model. The user may give this new signal a name or use the default name suggested by the system. A signal created in this manner can be a categorical signal that represents the condition of the associated asset. Additional GUI features can be added to allow a user to specify other types of data to be included in the converted model or to allow a user to select input signals for a composite model. The user may create duplicate signals under different names.

After the user designates the model output as a signal, the user may assign it to one or more Signal Groups (just like any other signal). Referring back to FIG. 3A, the user creates signals, for example, {Comp-1_M[1], Comp-2_M[2], Comp-3_M[3], Comp-4_M[4], Comp-5_M[5]} for models {M[1], M[2], M[3], M[4], M[5]}, respectively, via the GUI 900.

In an embodiment, all model outputs may be automatically generated in a way which allows that output to be used as signal data in another model in the same account Datastream.

Once converted into a signal, the signal can be used anywhere a signal is used. For example, during visualization, the expand/collapse feature may show/hide the signal in the timeline view. A set/reset feature may set/reset signal level properties, such gapThreshold, etc., of the signal.

As discussed above, newly converted signals may be used for building higher-level models. For example, the user may create the model M[6] using Signal Group “_equips1,” which includes three signals {Comp-1_M[1], Comp-2_M[2], S8} of which two are prediction signals and the third is sensor-based signal. Similarly, the user may create the model M[7] using Signal Group “equips2,” which includes two prediction signals {Comp-3_M[3], Comp-4_M[4]}, and the model M[8] using Signal Group “equips3,” which includes two prediction signal {Comp-4_M[4], Comp-5_M[5]}.

A higher-level (equipment unit) model M[9] is then created using Signal Group “_equipu-1,” which will include the signals converted from model output of models M[6], M[7], & M[8]. In Table B above, prediction signals named EquipS-1_M[6], EquipS-2_M[7], and EquipS-3_M[8] are created from the model output of M[6], M[7] and M[8], respectively.

This chaining continues on and further up until it reaches the “Plant X” (at Level 4). When necessary, this can be extended to higher-level categories for Installation (Level 3), Business Category (Level 2), finally the Industry (Level 1).

As discussed above, users are not limited to these 9-tier levels but are allowed to create a new level for their selection as may be relevant to their business needs. Not just a hierarchical organization, techniques described herein support organizing the system of assets in a graph structure to support a process flow.

These interconnected operational ML models then represent a digital twin of the interconnected systems of a complex system, such as an industrial plant. Users are able to monitor the performance of the asset at any level.

5.3. Model Comparison

A user may compare two assets at different levels by using models corresponding to selected assets. For example, if the user wants to compare component “Comp 1” and component “Comp 2,” then the user would pick the models M[1] and M[2], respectively. However, if the user wants to compare a component “Comp 1” and an equipment subunit “EquipS 1,” then the user would pick the models M[1] and M[6], respectively.

Via a GUI, both the models are highlighted and placed one above the other. The corresponding signal groups are shown in the same order as their models. Within the Signal Groups, the signals may be rank-ordered. In such a view, if there is a common signal used by both models, they will be repeated in both groups. FIG. 10 illustrates an example timeline view 1000 comparing multiple models. In Table B above, model M[1] uses all the signals of Signal Group “_comp1” and model M[2] uses all the signals of Signal Group “_comp2.” This information is used to identify and display the relevant signals. Alternatively, the system may use the information recorded in the “Model Used In” field.

5.4. Digital Twin

An analyzer, such as those shown in Tables B, C, and D, are containerized models that can be deployed in any computing environment that can run a docker container, such as a Raspberry PI, an Android-based smart phone, a laptop/PC, etc., for real-time monitoring of physical assets.

Condition output from Analyzers may be placed on a 2D static picture (e.g., geo-spatial map view) that can then be viewed based on a corresponding organization of assets. The user may either traverse through the structure of the organization and navigate from the geo-spatial map view to a specific asset, or use a search box to locate an asset of interest and directly navigate to the asset.

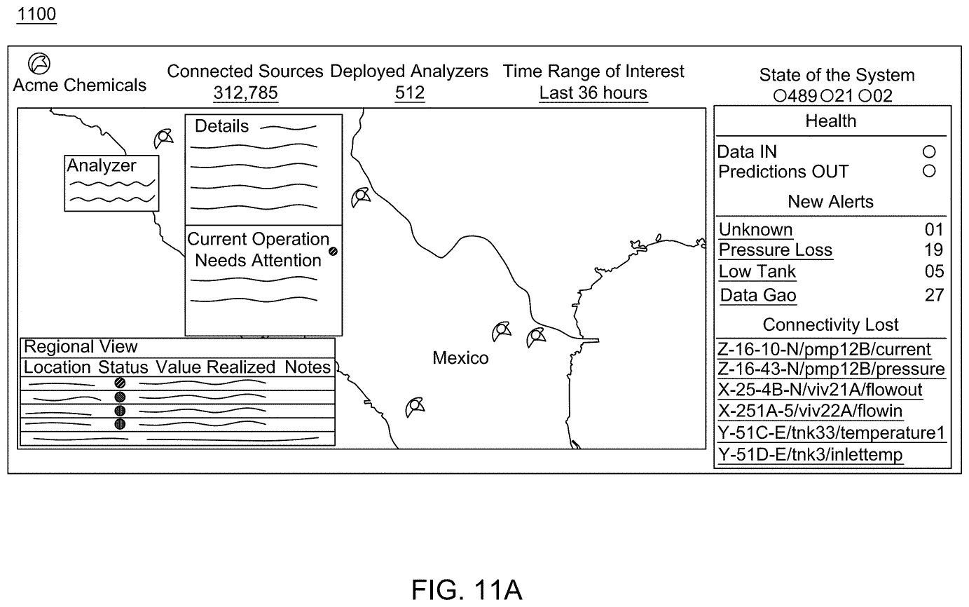

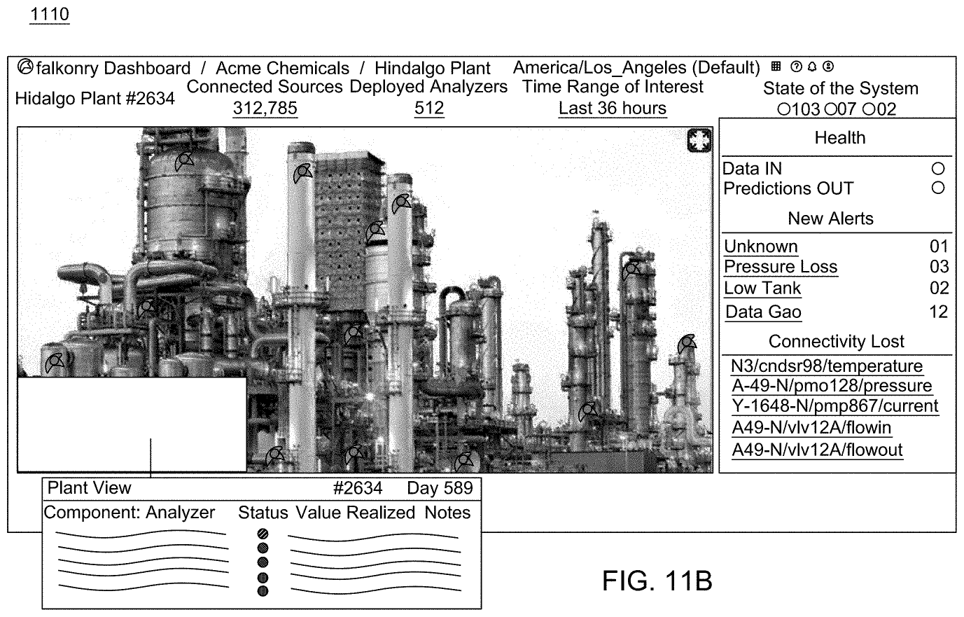

FIG. 11A illustrates an example display 1100 of installation-level analyzers monitored on a geo-spatial map along with installation level aggregation of different metrics. The display 1100 shows analyzers deployed at the installation level (Level 3) across the United States and Mexico.

FIG. 11B illustrates an example display 1110 installation-level analyzers monitored on a geo-spatial map along with plant level aggregation of different metrics. The display 1110 shows analyzers deployed at a plant level (Level 4).

In an embodiment, analyzers may be directly placed on an existing SCADA/DCS/HMI instead of a 2D static image. In an embodiment, analyzers may be directly placed on an existing 3D rendering instead of a 2D static image.

### 6.0. Procedural Overview

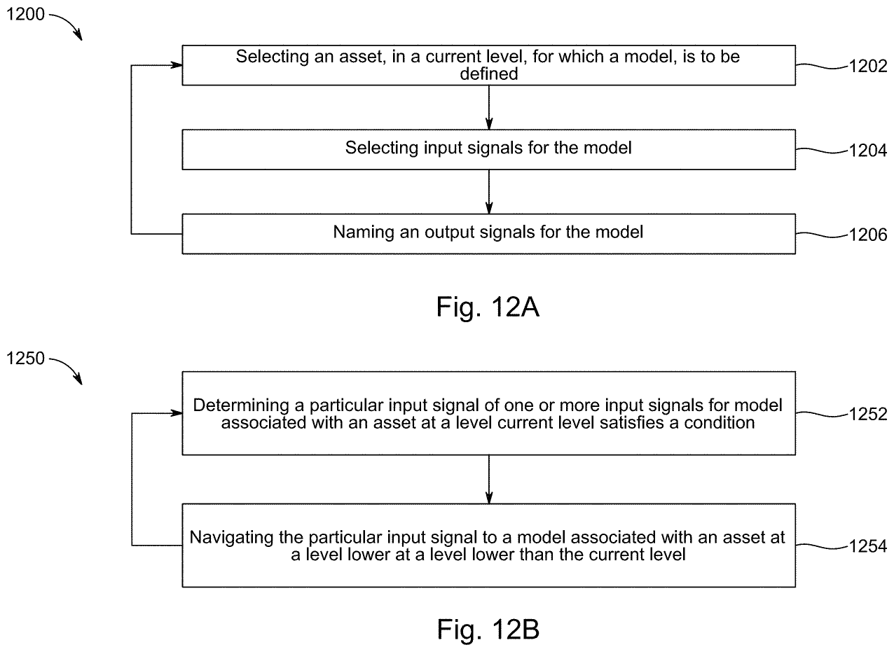

FIG. 12A illustrates an example method 1200 of building models in accordance with some embodiments. FIG. 12A may be used as a basis to code method 1200 as one or more computer programs or other software elements that the server computer 108 executes or hosts. FIG. 12A is illustrated and described at the same level of detail as used by persons of skill in the technical fields to which this disclosure relates for communicating among themselves about how to structure and execute computer programs to implement embodiments.

In an embodiment, method 1200 is performed at each level in a plurality of levels associated with an asset organization, starting from the bottommost level (e.g., Level 8), excluding the signal level (e.g., Level 10), of the asset organization. In an embodiment, the GUI 900 facilitates building models associated with the asset organization.

At step 1202, an asset in a current level is selected for which a model is to be defined. An example asset may be a part, a component, an equipment subunit, an equipment unit, a zone, or a plant of an industrial system.

At step 1204, input signals for the model are selected. The model determines conditions of the asset associated with the model based on the input signals. Input signals for a model may include operational signals from field sensors, prediction signals of models associated with assets that are located at a level lower than the current level, or a combination thereof.

At step 1206, an output signal for the model is named. The output signal would encode conditions predicted by the model. The output signal is a prediction signal that may be used by at least one model associated with an asset of the plurality of assets that is located at a level higher than the current level. For example, referring to FIG. 3A, model M[1] for “Comp 1,” a Level 8 asset, takes as input signals {S1, S2, S3, S6, S9}. Predictions made by “Comp 1” are encoded as a prediction signal which is an input to “EquipS 1” that is located at a higher level, namely Level 7.

In an embodiment, steps 1202-1206 are repeated for each asset in the current level.

After all models are built, associated assets are thereby connected or chained to form a model chain. Put differently, prediction signals output from a lower-level model may be used by any higher-level models. In the model chain, lower-level models may be more sensitive as they find patterns using just a few signals, and higher-level model then looks for patterns in the patterns of the lower-level models. In this manner, method 1200 accounts for all interactions between assets that generate signals while reducing the number of signals used by each model to find patterns.

After the model chain is formed, the models in the model chain may be applied using deep apply, in which lower-level models are applied on new signal data to generate new output that are required by higher-level models. Users are able to perform root cause analysis of complex systems efficiently and effectively as they are not blinded by subtle system behavior since failures at individual signal(s) only bubble up to the topmost model when a model at each level below indeed determines an error based on the pattern detected from its input signals.

FIG. 12B illustrates an example method of analyzing model performance in accordance with some embodiments. FIG. 12B may be used as a basis to code method 1250 as one or more computer programs or other software elements that the server computer 108 executes or hosts. FIG. 12B is illustrated and described at the same level of detail as used by persons of skill in the technical fields to which this disclosure relates for communicating among themselves about how to structure and execute computer programs to implement embodiments.

In an embodiment, method 1250 is performed by traversing a plurality of levels associated with an asset organization, starting from the topmost level (e.g., Level 4) of the asset organization. For discussion, assume that the asset organization is the one described with respect to method 1200 of FIG. 12A and that an error condition for the plurality of assets has been indicated or otherwise raised (e.g., a failure has bubbled up or has propagated downstream).

At step 1252, a particular input signal of one or more input signals for the model associated with the asset at a current level is determined to satisfy a user-defined criteria. An example of such a criteria might be the particular input signal having a highest explanation score for a particular “Error” condition among the one or more input signals used by the model associated with the asset at the current level of the hierarchy. Explanation scores for the one or more input signals may be determined by a performance model associated with the asset at the current level. Another example criteria is the particular input signal having a specific value (e.g., “error”).

At step 1254, the particular input signal is navigated to a model associated with an asset at a level lower than the current level.

In an embodiment, steps 1252 and 1254 are repeated until an asset of the plurality of assets is identified as a potential source of the error state. For example, steps 1252 and 1254 are repeated until an asset at the bottommost level (e.g., Level 8) is reached.

In an embodiment, a signal path associated with the traversal starting from the identified asset may be backtracked to another asset along the signal path and traversing the plurality of levels therefrom. For example, referring to FIG. 3A, after identifying “Comp 1” as a potential source of the error state of “Plant X,” the signal path of “Plant X”-“Zone 1”-“EquipU 1”-“EquipS 1”-“Comp 1” may be backtracked back to “EquipU 1” to traverse the plurality of assets from Level 6 to “EquipS 2.” Traversal from “EquipS 2” may lead to another potential source of the error of “Plant X.”

Techniques described herein enable predictive analytics systems to consider discrete and composite models (model of models) to be completely represented analytical models (or digital twin) of physical or logical asset formations on the ground. A composite model's input includes outputs of other models and zero or more sensor signals. The knowledge of which models are providing input to other models makes it possible and easy to navigate from one part of a complex system to another part of the complex system. The “Models Used In” information helps a user to navigate from a signal to one of the models. This bi-directional navigational ability enhances the end-user experience. Additionally, the user may start at any asset of interest and may use an entity/asset search bar in a GUI to locate an asset of interest. When one or more matches are found, the user may navigate to the corresponding digital twin model.

Consequently, the disclosed techniques provide numerous technical benefits. One example is reduced use of memory, CPU cycles, network traffic, and other computer resources, resulting in improved machine efficiency, for all the reasons set forth herein.

### 7.0. Hardware Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

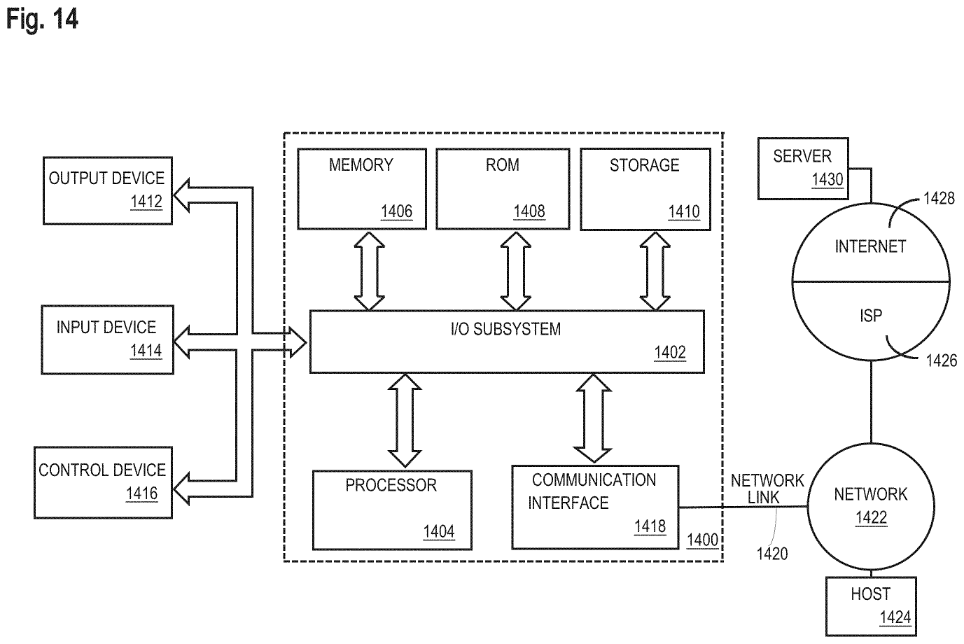

FIG. 14 is a block diagram that illustrates an example computer system with which an embodiment may be implemented. In the example of FIG. 14, a computer system 1400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 1400 includes an input/output (I/O) subsystem 1402 which may include a bus and/or other communication mechanism(s) for communicating information and/or instructions between the components of the computer system 1400 over electronic signal paths. The I/O subsystem 1402 may include an I/O controller, a memory controller and at least one I/O port. The electronic signal paths are represented schematically in the drawings, for example as lines, unidirectional arrows, or bidirectional arrows.

At least one hardware processor 1404 is coupled to I/O subsystem 1402 for processing information and instructions. Hardware processor 1404 may include, for example, a general-purpose microprocessor or microcontroller and/or a special-purpose microprocessor such as an embedded system or a graphics processing unit (GPU) or a digital signal processor or ARM processor. Processor 1404 may comprise an integrated arithmetic logic unit (ALU) or may be coupled to a separate ALU.

Computer system 1400 includes one or more units of memory 1406, such as a main memory, which is coupled to I/O subsystem 1402 for electronically digitally storing data and instructions to be executed by processor 1404. Memory 1406 may include volatile memory such as various forms of random-access memory (RAM) or other dynamic storage device. Memory 1406 also may be used for storing temporary variables or other intermediate information during execution of instructions to be executed by processor 1404. Such instructions, when stored in non-transitory computer-readable storage media accessible to processor 1404, can render computer system 1400 into a special-purpose machine that is customized to perform the operations specified in the instructions.

Computer system 1400 further includes non-volatile memory such as read only memory (ROM) 1408 or other static storage device coupled to I/O subsystem 1402 for storing information and instructions for processor 1404. The ROM 1408 may include various forms of programmable ROM (PROM) such as erasable PROM (EPROM) or electrically erasable PROM (EEPROM). A unit of persistent storage 1412 may include various forms of non-volatile RAM (NVRAM), such as FLASH memory, or solid-state storage, magnetic disk, or optical disk such as CD-ROM or DVD-ROM, and may be coupled to I/O subsystem 1402 for storing information and instructions. Storage 1410 is an example of a non-transitory computer-readable medium that may be used to store instructions and data which when executed by the processor 1404 cause performing computer-implemented methods to execute the techniques herein.

The instructions in memory 1406, ROM 1408 or storage 1410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format retrieving instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 1400 may be coupled via I/O subsystem 1402 to at least one output device 1412. In one embodiment, output device 1412 is a digital computer display. Examples of a display that may be used in various embodiments include a touch screen display or a light-emitting diode (LED) display or a liquid crystal display (LCD) or an e-paper display. Computer system 1400 may include other type(s) of output devices 1412, alternatively or in addition to a display device. Examples of other output devices 1412 include printers, ticket printers, plotters, projectors, sound cards or video cards, speakers, buzzers or piezoelectric devices or other audible devices, lamps or LED or LCD indicators, haptic devices, actuators, or servos.

At least one input device 1414 is coupled to I/O subsystem 1402 for communicating signals, data, command selections or gestures to processor 1404. Examples of input devices 1414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 1416, which may perform cursor control or other automated control functions such as navigation in a graphical interface on a display screen, alternatively or in addition to input functions. Control device 1416 may be a touchpad, a mouse, a trackball, or cursor direction keys for communicating direction information and command selections to processor 1404 and for controlling cursor movement on display 1412. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 1414 may include a combination of multiple different input devices, such as a video camera and a depth sensor.

In another embodiment, computer system 1400 may comprise an internet of things (IoT) device in which one or more of the output device 1412, input device 1414, and control device 1416 are omitted. Or, in such an embodiment, the input device 1414 may comprise one or more cameras, motion detectors, thermometers, microphones, seismic detectors, other sensors or detectors, measurement devices or encoders and the output device 1412 may comprise a special-purpose display such as a single-line LED or LCD display, one or more indicators, a display panel, a meter, a valve, a solenoid, an actuator or a servo.

When computer system 1400 is a mobile computing device, input device 1414 may comprise a global positioning system (GPS) receiver coupled to a GPS module that is capable of triangulating to a plurality of GPS satellites, determining and generating geo-location or position data such as latitude-longitude values for a geophysical location of the computer system 1400. Output device 1412 may include hardware, software, firmware and interfaces for generating position reporting packets, notifications, pulse or heartbeat signals, or other recurring data transmissions that specify a position of the computer system 1400, alone or in combination with other application-specific data, directed toward host 1424 or server 1430.

Computer system 1400 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 1400 in response to processor 1404 executing at least one sequence of at least one instruction contained in main memory 1406. Such instructions may be read into main memory 1406 from another storage medium, such as storage 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 1410. Volatile media includes dynamic memory, such as memory 1406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 1402. Transmission media can also take the form of acoustic or light waves, such as those generated during radio-wave and infra-red data communications.

Various forms of media may be involved in carrying at least one sequence of at least one instruction to processor 1404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 1400 can receive the data on the communication link and convert the data to a format that can be read by computer system 1400. For instance, a receiver such as a radio frequency antenna or an infrared detector can receive the data carried in a wireless or optical signal and appropriate circuitry can provide the data to I/O subsystem 1402 such as place the data on a bus. I/O subsystem 1402 carries the data to memory 1406, from which processor 1404 retrieves and executes the instructions. The instructions received by memory 1406 may optionally be stored on storage 1410 either before or after execution by processor 1404.

Computer system 1400 also includes a communication interface 1418 coupled to bus 1402. Communication interface 1418 provides a two-way data communication coupling to network link(s) 1420 that are directly or indirectly connected to at least one communication networks, such as a network 1422 or a public or private cloud on the Internet. For example, communication interface 1418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 1422 broadly represents a local area network (LAN), wide-area network (WAN), campus network, internetwork, or any combination thereof. Communication interface 1418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 1418 sends and receives electrical, electromagnetic, or optical signals over signal paths that carry digital data streams representing various types of information.

Network link 1420 typically provides electrical, electromagnetic, or optical data communication directly or through at least one network to other data devices, using, for example, satellite, cellular, Wi-Fi, or BLUETOOTH technology. For example, network link 1420 may provide a connection through a network 1422 to a host computer 1424.

Furthermore, network link 1420 may provide a connection through network 1422 or to other computing devices via internetworking devices and/or computers that are operated by an Internet Service Provider (ISP) 1426. ISP 1426 provides data communication services through a world-wide packet data communication network represented as internet 1428. A server computer 1430 may be coupled to internet 1428. Server 1430 broadly represents any computer, data center, virtual machine, or virtual computing instance with or without a hypervisor, or computer executing a containerized program system such as DOCKER or KUBERNETES. Server 1430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 1400 and server 1430 may form elements of a distributed computing system that includes other computers, a processing cluster, server farm or other organization of computers that cooperate to perform tasks or execute applications or services. Server 1430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format retrieving instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 1430 may comprise a web application server that hosts a presentation layer, application layer and data storage layer such as a relational database system using structured query language (SQL) or no SQL, an object store, a graph database, a flat file system or other data storage.

Computer system 1400 can send messages and receive data and instructions, including program code, through the network(s), network link 1420 and communication interface 1418. In the Internet example, a server 1430 might transmit a requested code for an application program through Internet 1428, ISP 1426, local network 1422 and communication interface 1418. The received code may be executed by processor 1404 as it is received, and/or stored in storage 1410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 1404. While each processor 1404 or core of the processor executes a single task at a time, computer system 1400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 8.0. Software Overview

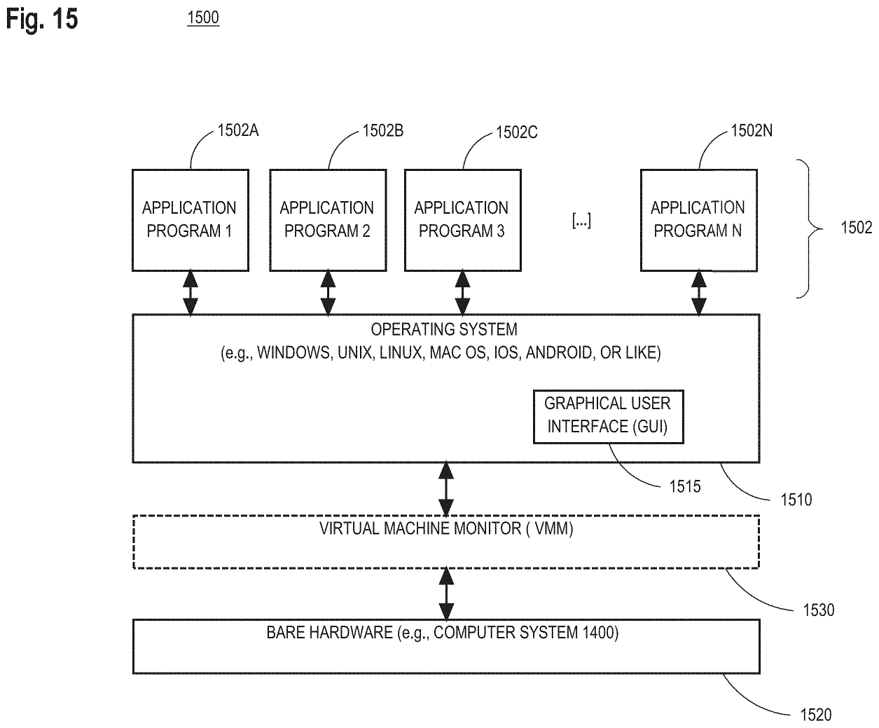

FIG. 15 is a block diagram of a basic software system 1500 that may be employed for controlling the operation of computing device 1400. Software system 1500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1500 is provided for directing the operation of computing device 1400. Software system 1500, which may be stored in system memory (RAM) 1406 and on fixed storage (e.g., hard disk or flash memory) 1410, includes a kernel or operating system (OS) 1510.

The OS 1510 manages low-level aspects of computer operation, including managing execution of processes, memory allocation, file input and output (I/O), and device I/O. One or more application programs, represented as 1502A, 1502B, 1502C . . . 1502N, may be “loaded” (e.g., transferred from fixed storage 1410 into memory 1406) for execution by the system 1500. The applications or other software intended for use on device 1500 may also be stored as a set of downloadable computer-executable instructions, for example, for downloading and installation from an Internet location (e.g., a Web server, an app store, or other online service).

Software system 1500 includes a graphical user interface (GUI) 1515, for receiving user commands and data in a graphical (e.g., “point-and-click” or “touch gesture”) fashion. These inputs, in turn, may be acted upon by the system 1500 in accordance with instructions from operating system 1510 and/or application(s) 1502. The GUI 1515 also serves to display the results of operation from the OS 1510 and application(s) 1502, whereupon the user may supply additional inputs or terminate the session (e.g., log off).

OS 1510 can execute directly on the bare hardware 1520 (e.g., processor(s) 1404) of device 1400. Alternatively, a hypervisor or virtual machine monitor (VMM) 1530 may be interposed between the bare hardware 1520 and the OS 1510. In this configuration, VMM 1530 acts as a software “cushion” or virtualization layer between the OS 1510 and the bare hardware 1520 of the device 1400.

VMM 1530 instantiates and runs one or more virtual machine instances (“guest machines”). Each guest machine comprises a “guest” operating system, such as OS 1510, and one or more applications, such as application(s) 1502, designed to execute on the guest operating system. The VMM 1530 presents the guest operating systems with a virtual operating platform and manages the execution of the guest operating systems.

In some instances, the VMM 1530 may allow a guest operating system to run as if it is running on the bare hardware 1520 of device 1400 directly. In these instances, the same version of the guest operating system configured to execute on the bare hardware 1520 directly may also execute on VMM 1530 without modification or reconfiguration. In other words, VMM 1530 may provide full hardware and CPU virtualization to a guest operating system in some instances.

In other instances, a guest operating system may be specially designed or configured to execute on VMM 1530 for efficiency. In these instances, the guest operating system is “aware” that it executes on a virtual machine monitor. In other words, VMM 1530 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### 9.0 Other Aspects of Disclosure

In the foregoing specification, embodiments of the invention have been described with reference to numerous specific details that may vary from implementation to implementation. Thus, the sole and exclusive indicator of what is the invention and, is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

As used herein the terms “include” and “comprise” (and variations of those terms, such as “including”, “includes”, “comprising”, “comprises”, “comprised” and the like) are intended to be inclusive and are not intended to exclude further features, components, integers or steps.

Various operations have been described using flowcharts. In certain cases, the functionality/processing of a given flowchart step may be performed in different ways to that described and/or by different systems or system modules. Furthermore, in some cases a given operation depicted by a flowchart may be divided into multiple operations and/or multiple flowchart operations may be combined into a single operation. Furthermore, in certain cases the order of operations as depicted in a flowchart and described may be able to be changed without departing from the scope of the present disclosure.

It will be understood that the embodiments disclosed and defined in this specification extends to all alternative combinations of two or more of the individual features mentioned or evident from the text or drawings. All of these different combinations constitute various alternative aspects of the embodiments.

What is claimed is:

1. A computer-implemented method comprising:
receiving an indication of an error state of a specific asset of a plurality of assets that is arranged in a hierarchy of a plurality of levels,
wherein each asset of the plurality of assets is associated with at least one component of an industrial system,
wherein the plurality of levels includes a top level, a bottom level, and one or more intermediary levels between the top level and the bottom level,
wherein each of the plurality of assets is associated with a machine learning (ML) model,
wherein a first ML model associated with a first asset of the plurality of assets that is at the bottom level is configured to receive one or more signals corresponding to one or more values of sensors attached to one or more components of the industrial system in real time relative to generation of the one or more values,
wherein a second ML model associated with a second asset of the plurality of assets that is at the bottom level or at the one or more intermediary levels is configured to receive one or more signals to predict a condition of the second asset as output of the second ML model, wherein the output of the second ML model is used as an input signal by at least a third ML model associated with a third asset of the plurality of assets that is higher in the hierarchy than the second asset; and
performing a diagnosis of the error state by traversing the hierarchy of the plurality of levels from the top level,
wherein the traversing the hierarchy comprises:
determining a particular input signal of one or more input signals for a ML model associated with an asset at a current level of the hierarchy satisfies a criterion;
following the particular input signal to an ML model associated with an asset at a level lower than the current level, thereby visiting the asset at the lower level; and
repeating the determining and the following until an asset of the plurality of assets is identified as a potential source of the error state.

2. The computer-implemented method of claim 1, further causing a display of information regarding the potential source of the error state, including identification of at least one signal traversed and at least one asset visited in the diagnosis.

3. The computer-implemented method of claim 1, wherein the one or more signals received by the second ML model include an output signal of a fourth ML model associated with a fourth asset of the plurality of assets that is lower in the hierarchy than the second asset in real time relative to generation of that output signal.

4. The computer-implemented method of claim 1, wherein the one or more signals received by the second ML model include a signal corresponding to one of the sensors in real time relative to generation of that signal.

5. The computer-implemented method of claim 1, wherein the criterion is indicating an error or is indicating a best explanation for the error state among the one or more input signals used by the ML model associated with the asset at the current level of the hierarchy.

6. The computer-implemented method of claim 5, wherein explanations include explanation scores of the one or more input signals used by the ML model associated with the asset at the current level, wherein the explanation scores are determined by a performance model associated with the asset at the current level.

7. The computer-implemented method of claim 1, wherein the traversing further comprises backtracking a signal path to a parent asset of the plurality of assets and following another input signal of the parent asset.

8. The computer-implemented method of claim 7, wherein the backtracking is in response to determining that an asset associated with the highest explanation score is not in an error state.

9. The computer-implemented method of claim 1, wherein each of the plurality of assets is associated with a performance model that is configured to determine an explanation score for each signal received as input to a ML model associated with a respective asset.

10. The computer-implemented method of claim 1, wherein the ML model corresponds to a logical grouping of one or more assets of the plurality of assets.

11. One or more non-transitory computer-readable storage media storing one or more instructions programmed for analyzing model performance, when executed by one or more computing device cause:
receiving an indication of an error state of a specific asset of a plurality of assets that is arranged in a hierarchy of a plurality of levels,
wherein each asset of the plurality of assets is associated with at least one component of an industrial system,
wherein the plurality of levels includes a top level, a bottom level, and one or more intermediary levels between the top level and the bottom level,
wherein each of the plurality of assets is associated with a machine learning (ML) model,
wherein a first ML model associated with a first asset of the plurality of assets that is at the bottom level is configured to receive one or more signals corresponding to one or more values of sensors attached to one or more components of the industrial system in real time relative to generation of the one or more values,
wherein a second ML model associated with a second asset of the plurality of assets that is at the bottom level or at the one or more intermediary levels is configured to receive one or more signals to predict a condition of the second asset as output of the second ML model, wherein the output of the second ML model is used as an input signal by at least a third ML model associated with a third asset of the plurality of assets that is higher in the hierarchy than the second asset; and
performing a diagnosis of the error state by traversing the hierarchy of the plurality of levels from the top level,
wherein the traversing the hierarchy comprises:
determining a particular input signal of one or more input signals for a ML model associated with an asset at a current level of the hierarchy satisfies a criterion;
following the particular input signal to a ML model associated with an asset at a level lower than the current level, thereby visiting the asset at the lower level; and
repeating the determining and the following until an asset of the plurality of assets is identified as a potential source of the error state.

12. The one or more non-transitory computer-readable storage media claim 11, wherein the one or more instructions, when executed by the one or more computing device further cause causing a display of information regarding the potential source of the error state, including identification of at least one signal traversed and at least one asset visited in the diagnosis.

13. The one or more non-transitory computer-readable storage media claim 11, wherein the one or more signals received by the second ML model include an output signal of a fourth ML model associated with a fourth asset of the plurality of assets that is lower in the hierarchy than the second asset in real time relative to generation of that output signal.

14. The one or more non-transitory computer-readable storage media claim 11, wherein the one or more signals received by the second ML model include a signal corresponding to one of the sensors in real time relative to generation of that signal.

15. The one or more non-transitory computer-readable storage media claim 11, wherein the criterion is indicating an error or is indicating a best explanation for the error state among the one or more input signals used by the ML model associated with the asset at the current level of the hierarchy.

16. The one or more non-transitory computer-readable storage media claim 15, wherein explanations include explanation scores of the one or more input signals used by the ML model associated with the asset at the current level, wherein the explanation scores are determined by a performance model associated with the asset at the current level.

17. The one or more non-transitory computer-readable storage media claim 11, wherein the traversing further comprises backtracking a signal path to a parent asset of the plurality of assets and following another input signal of the parent asset.

18. The one or more non-transitory computer-readable storage media claim 17, wherein the backtracking is in response to determining that an asset associated with the highest explanation score is not in an error state.

19. The one or more non-transitory computer-readable storage media claim 11, wherein each of the plurality of assets is associated with a performance model that is configured to determine an explanation score for each signal received as input to a ML model associated with a respective asset.

20. The one or more non-transitory computer-readable storage media claim 11, wherein the ML model corresponds to a logical grouping of one or more assets of the plurality of assets.
